(19) United States
(12) Patent Application Publication
(10) Pub. No.: US 2025/0077849 A1
(43) Pub. Date: Mar. 6, 2025

(54) STAGED PAYLOAD SERIES GENERATION BY LARGE LANGUAGE MODELS

(71) Applicant: Airship Group, Inc., Portland, OR (US)

(72) Inventors: Melissa Deziel, Brooklyn, NY (US); Adam David Coddington, Portland, OR (US); Michael Cold, Portland, OR (US); Nathan Mark Wittstock, Portland, OR (US)

(21) Appl. No.: 18/821,818

(22) Filed: Aug. 30, 2024

Related U.S. Application Data
(60) Provisional application No. 63/535,546, filed on Aug. 30, 2023.

(51) Int. Cl. G06N 3/0475; G06N 3/09

(52) U.S. Cl. CPC G06N 3/0475; G06N 3/09

(57) ABSTRACT

A payload management server designs a payload series using a large language model (LLM). The payload management server receives inputs from a publisher describing a payload series to be sent to a payload recipient, generates a prompt for the LLM based on the received inputs, provides the prompt to a model serving system for execution by the LLM, and receives from the model serving system the message series generated by executing the LLM on the prompt. The payload management server may transmit payloads of the generated payload series to the payload recipient.

### CROSS-REFERENCE TO RELATED APPLICATIONS

This application claims the benefit of U.S. Provisional Patent Application No. 63/535,546 filed Aug. 30, 2023, which is incorporated by reference in its entirety.

### BACKGROUND

Communication channels are often associated with their own requirements, protocols, and limitations. An organization may encounter technical difficulties in trying to transmit a message designed for one channel via another channel. The appearance, contents, and overall feeling of the message may be changed significantly when a different channel is used to deliver the message. In some cases, the change in channels may render the message completely undeliverable. On one hand, an organization may not be equipped with the technical specialty to freely switch messages between channels. On the other hand, sending messages through a single channel or a limited set of channels may not be an effective communication strategy.

Additionally, transmitting messages may be challenging in an environment where communication is interactive, such as when the message recipient may interact with a server based on the messages sent. Responding to these messages and interacting with a message recipient may require human intervention in the form of a manual response. This may create undesired delays in responding to the message recipient.

### BRIEF DESCRIPTION OF THE DRAWINGS

FIG. 1 is a block diagram illustrating an example system environment, in accordance with an embodiment.

FIG. 2 is a block diagram illustrating various components of an example message management server, in accordance with some embodiments.

FIG. 3 is an example message object hierarchy that may be used with the message management server, in accordance with some embodiments.

FIG. 4 is an interaction diagram illustrating interactions among various entities to manage in-app UI messages, in accordance with some embodiments.

FIG. 5A is an interaction diagram illustrating interactions among various entities to manage in-app preference centers, in accordance with some embodiments.

FIG. 5B is a flowchart for a method of generating a message series with a large language model (LLM), in accordance with some embodiments.

FIG. 5C is a flowchart for a method of inferring whether an automated response or action can be generated for a message, in accordance with some embodiments.

FIG. 6A illustrates an example graphical user interface (GUI) configured to receive configuration data describing settings for an in-app tour, in accordance with some embodiments.

FIG. 6B illustrates an example GUI configured to receive configuration data describing target users for an in-app tour, in accordance with some embodiments.

FIG. 6C illustrates an example GUI configured to receive configuration data describing content for an in-app tour, in accordance with some embodiments.

FIG. 6D illustrates an example GUI configured to receive configuration data describing trigger conditions for an in-app tour, in accordance with some embodiments.

FIG. 6E illustrates an example GUI configured to receive input from a user for use in generating a journey.

FIG. 7A illustrates an example GUI configured to receive configuration data describing general information for a new in-app preference center, in accordance with some embodiments.

FIG. 7B illustrates an example GUI configured to receive configuration data describing functionality for an in-app preference center UI, in accordance with some embodiments.

FIG. 8 is an example of a visual representation of a primary message plan that includes real time statistics, in accordance with some embodiments.

FIG. 9 is a block diagram illustrating components of an example computing machine, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Disclosed embodiments herein are related to a message management server that provides a platform for message publishers to build different messages for distribution to one or more computing devices. Some of the communications to an end user may be presented in the form of an in-application (in-app) user interface (UI) overlay and in-app UI messages including configuration data describing one or more in-app UI elements for presentation within an application installed on the one or more message recipient computing devices. The messages are transmitted to message recipients via different channels, such as a software development kit (SDK) corresponding to an application on a message recipient computing device. The SDK may be operated by the message management server. A message publisher may specify various conditions for the communications, such as trigger conditions for an in-app UI overlay to be presented to a message recipient. The message management server or the SDK may monitor event notifications related to the message recipients and send messages when conditions are met. The message management server or the SDK may additionally or alternatively monitor event notifications related to the message recipients and send an automated response to the message recipient. Each message may be sent via a different channel as specified by the message recipients.

The message management server may provide a platform that includes one or more graphical user interfaces configured to facilitate design of messages, e.g., by providing previews of the messages as rendered in various end user device models when the messages are delivered via the specified channels. The platform allows the message publisher to design various communication elements such as UI overlay elements, dynamic preferences in the application, surveys, and message series and to select the channels for distribution of various communication elements.

In some embodiments, the message management server designs a message series using a large language model (LLM). The message management server receives inputs from a message publisher describing a message series to be sent to a message recipient, generates a prompt for the LLM based on the received inputs, provides the prompt to a model serving system for execution by the LLM, and receives from the model serving system the message series generated by executing the LLM on the prompt. The message management server may transmit messages of the generated message series to the message recipient.

### Example System Environment

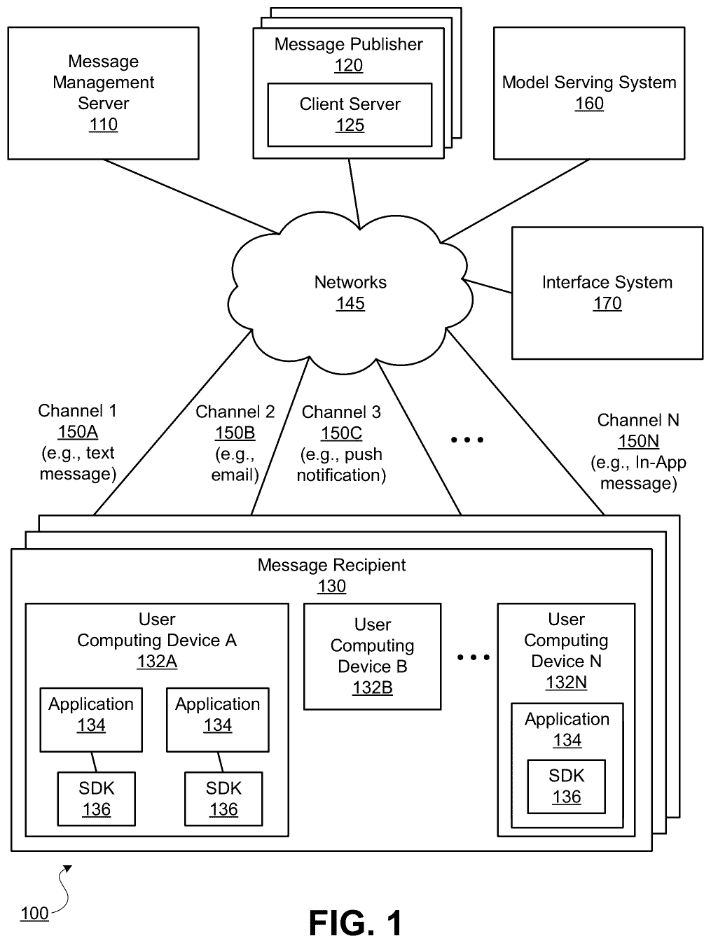

Referring now to Figure (FIG. 1, shown is a block diagram illustrating an embodiment of an example system environment 100 for delivering in-app UI overlays and dynamic preference options for software applications, in accordance with an embodiment. By way of example, the system environment 100 includes a message management server 110, one or more computing devices associated with one or more message publishers 120, one or more message recipients 130 who possess user computing devices 132, a model serving system 160, and an interface system 170. Each message recipient 130 may be associated with one or more user computing devices 132 (e.g., 132A, 132B, . . . , 132N (N being an nth device, n being some number; generally computing devices 132)). The entities and components in the system environment 100 may communicate with each other through networks 145. The message management server 110 may communicate with various user computing devices 132 through different channels 150 (e.g., 150A, 150B, 150C, . . . , 150N (N being an nth device, n being some number); generally channels 150). In various embodiments, the system environment 100 may include fewer or additional components. The system environment 100 also may include different components. Also, while some of the components in the system environment 100 may sometimes be described in a singular form, the system environment 100 may include one or more of each of the components. For example, there may be multiple message publishers 120 and multiple message recipients 130. Various message publisher 120 may be independent entities such as different customers of the message management server 110, which serves as a service provider that manages the message distribution and associated actions on behalf of the message publishers 120.

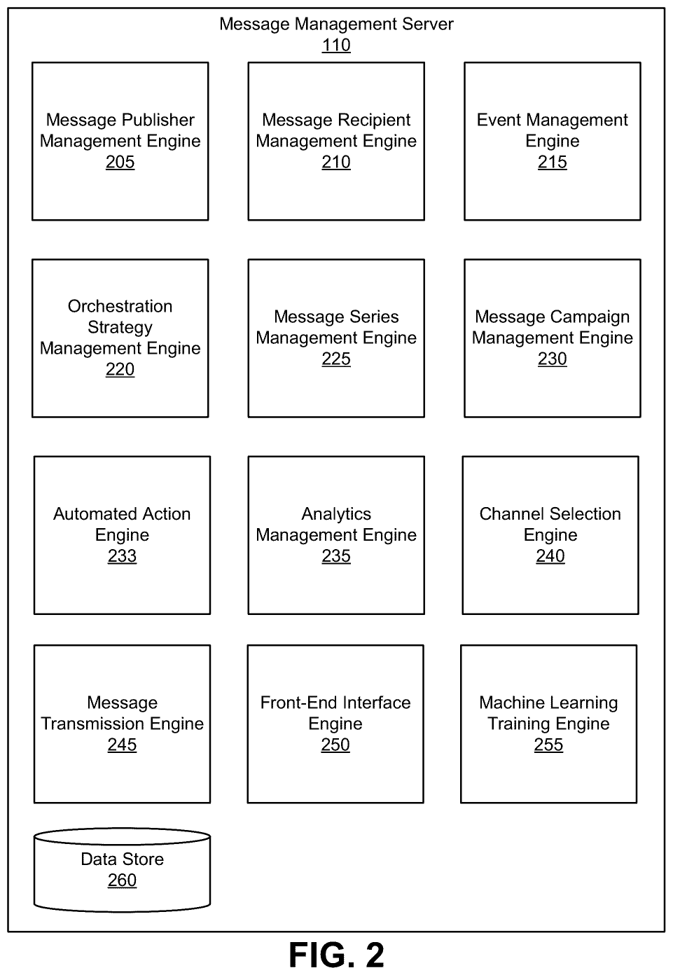

The message management server 110 may include one or more computers that perform various tasks related to configuring various types of communication elements for different message publishers 120, responding to messages from various message recipients 130 on behalf of the different message publishers 120, transmitting communication elements to various message recipients 130 on behalf of the different message publishers 120, determining conditions and channels to transmit various communications, transmitting a series of messages using different channels 150, receiving responses from message recipients 130, forwarding the responses to the message publishers 120, and, in some cases, taking actions on behalf of the message publishers 120 based on the responses from the message recipients 130. A message management server 110 may also be referred to as a payload management server 110. Communication elements may include in-app UI overlay, dynamic preference center, two-way messaging series, in-app survey, messages, and other suitable communications. For example, the message management server 110 may launch a two-way messaging campaign on behalf of a message publisher 120. The message management server 110 may send one or more messages to a message recipient 130 to solicit a response from the message recipient 130. Based on the response, the message management server 110 may respond to the message from the message recipient 130 or perform actions on behalf of the message publisher 120. In another example, the message management server 110 may launch a cross-channel re-engagement campaign on behalf of a message publisher 120. A message recipient 130, who may be a customer of the message publisher 120, may have been inactive with the message publisher 120. The message management server 110 may send messages through different channels to attract the message recipient 130 to re-engage with the message publisher 120. Implementation of transmission of messages through different channels may be referred to as a message orchestration. The message management server 110 may facilitate drafting, configuration, and/or transmittal of various types of messages, such as text messages, emails, push-notifications, browser notifications, in-applications (in-app) user interface (UI) messages, or other in-app messages. In particular, various embodiments relating to configuring, transmitting, displaying, and/or processing user interactions with in-app UI messages, which may take the form of UI overlay, are described in greater detail below with reference to FIGS. 2, 4-5, 6A-D, and 7A-B. As will be described in greater detail below, in-app UI messages include configuration data for one or more UI elements for integration into interfaces of an application. Example UI elements include widgets, input controls (e.g., buttons, switches, etc.), navigational controls, banners, various media (e.g., images, icons, etc.), standalone UIs, etc. Although in-app UI messages are described herein in relation to graphical user interfaces (GUIs), one skilled in the art will appreciate that other types of UIs may be possible (e.g., audio user interfaces).

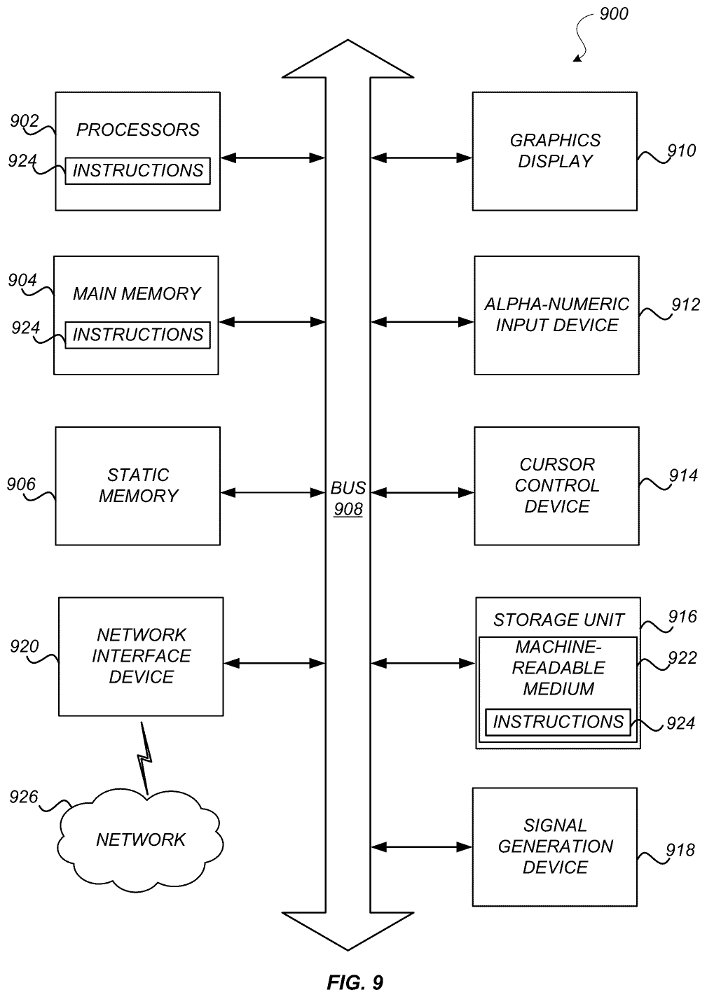

The message management server 110 may include a combination of hardware and software. The message management server 110 may include some or all example components of a computing machine described with FIG. 9. The message management server 110 may also be referred to as a message managing platform or simply a computing server. The management server 110 may take different forms. In one embodiment, the message management server 110 may be a server computer that executes code instructions to perform various processes described herein. In another case, the message management server 110 may be a pool of computing devices that may be located at the same geographical location (e.g., a server room) or be distributed geographically (e.g., clouding computing, distributed computing, or in a virtual server network). The message management server 110 may also include one or more virtualization instances such as a container, a virtual machine, a virtual private server, a virtual kernel, or another suitable virtualization instance. The message management server 110 may provide message publishers 120 with various message management services and merchant services as a form of cloud-based software, such as software as a service (SaaS), through the networks 145. Examples of components and functionalities of the message management server 110 are discussed in further detail below with reference to FIG. 2.

Message publishers 120 are various organizations and individuals that interact with the message management server 110. A message publisher may simply be referred to as a publisher or a payload publisher. The message publishers 120 may be the customers of the message management server 110. The message publishers 120 can be of different natures and can be any suitable types of organizations, natural persons, or robotic devices. For example, a message publisher 120 can be an administrator and/or developer of a software application, such as software applications 134 described in greater detail below. In another example, a message publisher 120 can be a government entity that provides important or emergency messages to citizens. In another example, a message publisher 120 can be an educational institute that sends announcements to its students through different channels 150. Some message publishers 120 may also be private businesses or individuals. In one case, a retail business may be a message publisher 120 that uses the service of the message management server 110 to distribute marketing announcements and advertisements to various message recipients 130. In another case, another retail business may use the message management server 110 to transmit gift cards, coupons, store credits, and receipts as various forms of messages to message recipients 130. In yet another case, a message publisher 120 may be an airline that sends passes (e.g., boarding passes) and flight status updates to message recipients 130. In yet another case, a message publisher 120 may be a bank that sends statements and payment reminders to message recipients 130. In yet another case, a message publisher 120 may be a news organization that sends news and articles to its subscribers. In yet another case, a message publisher 120 may be a social networking system that sends feeds and contents to message recipients 130. In yet another case, a message publisher 120 may be an individual who sends messages to his families, friends, and other connected individuals. In yet another case, a message publisher 120 may be a retail company that sends offers to its customers and the customers may make in-app purchase by directly responding to the message. These are non-exhaustive examples of message publishers 120. A message publisher 120 may be an independent entity of the message management server 110 or may control the message management server 110, depending on embodiments. Various message publishers 120 may be independent and unrelated entities, such as different unrelated businesses.

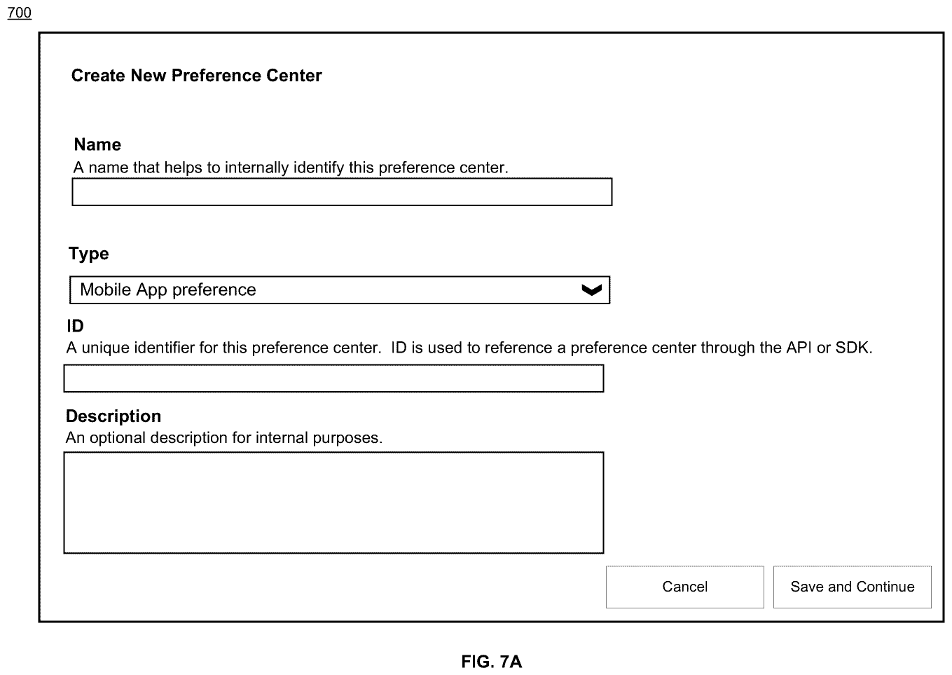

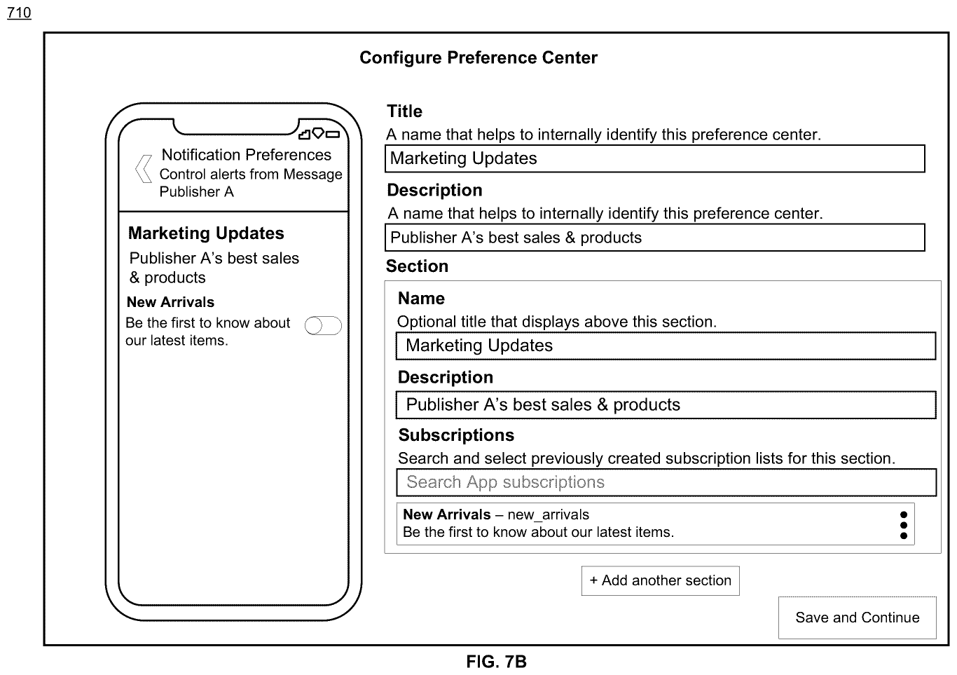

Each message publisher 120 may be associated with one or more client servers 125 that are used to communicate with the message management server 110 and message recipients 130. The client servers 125 may also be referred to as message publisher servers 125, message publisher devices 125 or client devices 125. Each client server 125 may be a computing device that can transmit and receive data via the networks 145. The client server 125 may include some or all of the example components described with FIG. 7. A client server 125 performs operations of various day-to-day tasks of the corresponding message publisher 120. For example, a bank (an example message publisher 120) may include a server 125 that manages the balances of accounts of its customers, processes payments and deposits, and performs other banking tasks. In another example, an airline (another example message publisher 120) may include a server 125 that manages the flight statuses, generate boarding passes, and manages bookings of the customers. A client server 125 may also be a server for controlling and operating software applications 132 that are published by the message publisher 120 and are installed at different user computing devices 132. The precise operations of a client server 125 may depend on the nature of the corresponding message publisher 120.

A message publisher 120 may interact directly with its customers or end users, who are examples of message recipients 130, and may delegate certain operations, such as drafting messages or sending certain types of messages, to the message management server 110. A message publisher 120 may maintain accounts of its users and manage day-to-day interactions with the users while directing the message management server 110 to draft or distribute messages to the users on behalf of the message publisher 120. For example, in some embodiments, the message publisher 120 may use a message management system provided by the message management server 110 to design messages and set conditions, channels, and intended recipients of the messages. Additionally or alternatively, the message management server 110 may automatically draft or design the messages. The message publisher 120, through the message management server 110, may launch a message campaign that includes an individual messages or a series of messages to be automatically delivered to various message recipients 130. The message campaign may involve delivering various communication elements through different channels 150. Additionally, the message campaign may involve providing one or more in-app UI messages describing configurations for in-app UI elements for display to message recipients 130, such as via in-app display in an application 134 on a user computing device 132. The message campaign may also be a two-way messaging campaign that allows message recipients 130 to provide one or more responses. In some cases, the message management server 110 may take different actions based on the responses provided by the message recipients 130.

In some embodiments, a message may be considered to be transmitted from the message publisher 120 regardless of whether the message publisher's server directly sends the message or the message management server 110 sends the message.

To design an individual message or a message campaign, or to perform some other operations, a message publisher 120 may communicate with the message management server 110 through the client server 125 or a computing device associated with the message publisher 120. The methods of communication may vary depending on embodiments and circumstances. For example, an individual associated with a message publisher 120 (e.g., an employee) may communicate with the message management server 110 through a web application that is run by a web browser such as CHROME, FIREFOX, SAFARI, INTERNET EXPLORER, EDGE, etc. In another case, the message management server 110 may publish a mobile application or a desktop application that includes a graphical user interface (GUI). An individual associated with a message publisher 120 may use the mobile or desktop application to communicate with the message management server 110. In yet another case, a client server 125 may communicate directly with the message management server 110 via other suitable ways such as application program interfaces (APIs).

A message recipient 130 is an intended recipient of communication elements that may be designed by a message publisher 120 and sent from the message management server 110. A message recipient may also be referred to as a payload recipient who receives data payload that can take the form of messages, UI design changes, in-app code changes, multimedia files, and other payloads. A message may also be referred to a content payload or data payload. Message recipients 130 may be users, customers, subscribers, viewers, or any suitable message recipients of the message publisher 120. Message recipients 130 may also be referred to as end users or simply users. Message recipients 130 can be individuals, organizations, or even robotic agents. Each message recipient 130 may possess one or more user computing devices 132. The user computing devices 132A, 132B, . . . 132N may be of different kinds. For example, a user may have a smart phone, a laptop computer, and a tablet. One or more user computing devices 132 may have the components of a computing machine illustrated in FIG. 7. Examples of user computing devices 132 include personal computers (PC), desktop computers, laptop computers, tablets (e.g., iPADs), smartphones, wearable electronic devices such as smartwatches, smart home appliances (e.g., smart home hubs and controllers), vehicle computer systems, or any other suitable electronic devices.

User computing devices 132 may also include one or more Internet-of-Things (IoT) devices. An IoT device may be a network-connected device embedded in a physical environment (e.g., building, vehicles, appliances (home or office), etc.). In some cases, an IoT device has general processing power that is comparable to a computer. In other cases, an IoT device may have limited processing resources, low power, and limited bandwidth for communications. For example, an IoT device may be a sensor. An IoT device may be configured to gather and provide information about its physical environment. In various embodiments, an IoT device connects to the network 145 to provide information gathered from and/or associated with the environment. Data may be gathered through one or more sensors associated with the device and/or through inputs received through the device.

Some of the user computing devices 132 may be installed with an application 134 that is developed and operated by the message publisher 120. The application 134 or a portion of it may be developed using a software development kit (SDK) 136 provided by the message management server 110. For example, the application 134 may import the SDK 136 as part of the application 134. At the code level, this may be done by importing one or more libraries of functions and codes of the SDK 136 to the software code of the application 134 in the header section of the software code and having the code calling one or more functions of the SDK 136. While the message publisher 120 primarily operates the application 134, the SDK 136 allows the user computing device 132 to communicate with the message management server 110. For example, an example message publisher 120 may be a retail business that develops an application 134 for its customers to purchase items through the application 134. A customer may opt-in to allow the application 134 to track certain analytics. The analytics may be forwarded to the message management server 110 through the SDK 136. In another example, the message management server 110 may send in-application messages (in-app messages) to the message recipient 130 through the SDK 136. Upon the receipt of the message, the SDK 136 forwards the message to the software application for the message to be displayed in the application 134.

The application 134 may run on Swift for iOS and other APPLE operating systems or on Java or another suitable language for ANDROID systems. In another case, an application 134 may be a software program that operates on a desktop computer that runs on an operating system such as LINUX, MICROSOFT WINDOWS, MAC OS, or CHROME OS. A user computing device 132 may be installed with different applications 134. Each application 134 may be developed by different creators. For example, in some embodiments, a first application 134 is developed by a first message publisher 120 and a second application 134 is developed by a second message publisher 120.

The SDK 136 developed by the message management server 110 may be included by multiple applications 134. For example, multiple message publishers 120 may be customers of the message management server 110 and include the SDK 136 in the applications 134 developed by the message publishers 120, as illustrated in the user computing device A 132A. Each application 134 may communicate to an instance of the SDK 136 through the functions and libraries of the SDK 136 included in the application 134. Each instance of the SDK 136 may be associated with a unique SDK identifier that is used to identify the instance of the SDK 136 in a particular user computing device 132. Each application 134 that includes the SDK 136 may be associated with a unique channel identifier that is used to identify the application 134 by the message management server 110. For example, when a new application 134 is installed in a user computing device 132 and the new application 134 has imported the functionality of the SDK 136, the message management server 110 may assign a new channel identifier for the newly installed application 134. The message management server 110 may send in-app messages to different applications through the SDK 136 by using different channel identifiers.

In some embodiments, the SDK 136 manages in-app UI overlay and dynamic preference options provided to message recipients 130. In-app UI overlay includes data describing configurations for in-app UI elements for in-app display within the application 134 on a user computing device 132. Dynamic preference options are option menus that can be used to change one or more configuration of an application 134. The option menus are dynamic because a message publisher 120 may change the items in the option menus through the message management server 110 without causing a change of computer code or an update to the application 134. As such, non-computer programmers (e.g., business personnel) may be able to change the configuration of the application 134 and provide new options to the end users without having to request the software developer to launch a new software version.

The SDK 136 may communicate with the message management server 110 to receive or otherwise obtain in-app UI messages including configuration data corresponding to in-app UI elements, such as configuration data defining display constraints or criteria, display styles, assets, trigger conditions, channels, intended recipients, or other suitable data usable to render in-app UI elements. The SDK 136 may further communicate with the application 134 in order to render in-app UI elements within the application 134, such as to augment a UI of the application 134 with a UI element (e.g., via a popup or modal) or to navigate to a standalone UI provided by the message management server from a UI of the application 134. In some embodiments, the configuration data for an in-app UI element includes representation of a design of the in-app UI element (e.g., a markup language or data structure) as provided via one or more GUIs or other interfaces of the message management server 110, such as by the message publisher 120. In this case, the SDK 136 may process the design representations (e.g., markup language, CSS schemes, or other front-end UI elements and configurations) in order to render the in-app UI element for display within the application 134. The SDK 136 may additionally, or alternatively, process user interactions with in-app UI elements via communication with one or both of the application 124 and the message management server 110. Various embodiments of the SDK 136 managing in-app UI messages transmitted by the message management server 110 are described in greater detail below with reference to FIGS. 2 and 4-5.

The message management server 110 may associate end users with SDK identifiers and channel identifiers to identify the applications 134 and the computing devices 132 that are possessed by a particular end user. The identification of the end users may allow the message management server 110 to send cross-channel messages to a particular end user. In some embodiments, when a new application 134 is installed in a user computing device 132, the message management server 110 may associate the new channel identifier with the end user. Based on pre-authorization or upon the user's authorization when prompted, the end user may use the user-specific information and credentials that are saved in the message management server 110 or another source for the new application 134 without having to re-enter the information. The user may perform certain in-app actions, such as purchases, with simplified procedures, such as without having to re-enter payment information or verifying credentials.

The networks 145 provide connections to the components of the system environment 100 through one or more sub-networks, which may include any combination of the local area and/or wide area networks, using both wired and/or wireless communication systems. In one embodiment, the networks 145 use standard communications technologies and/or protocols. For example, a network 145 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 145 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 145 may be represented using any suitable format, such as hypertext markup language (HTML), extensible markup language (XML), JavaScript object notation (JSON), structured query language (SQL). In some embodiments, all or some of the communication links of a network 145 may be encrypted using any suitable technique or techniques such as secure sockets layer (SSL), transport layer security (TLS), virtual private networks (VPNs), Internet Protocol security (IPsec), etc. The networks 145 also include links and packet switching networks such as the Internet.

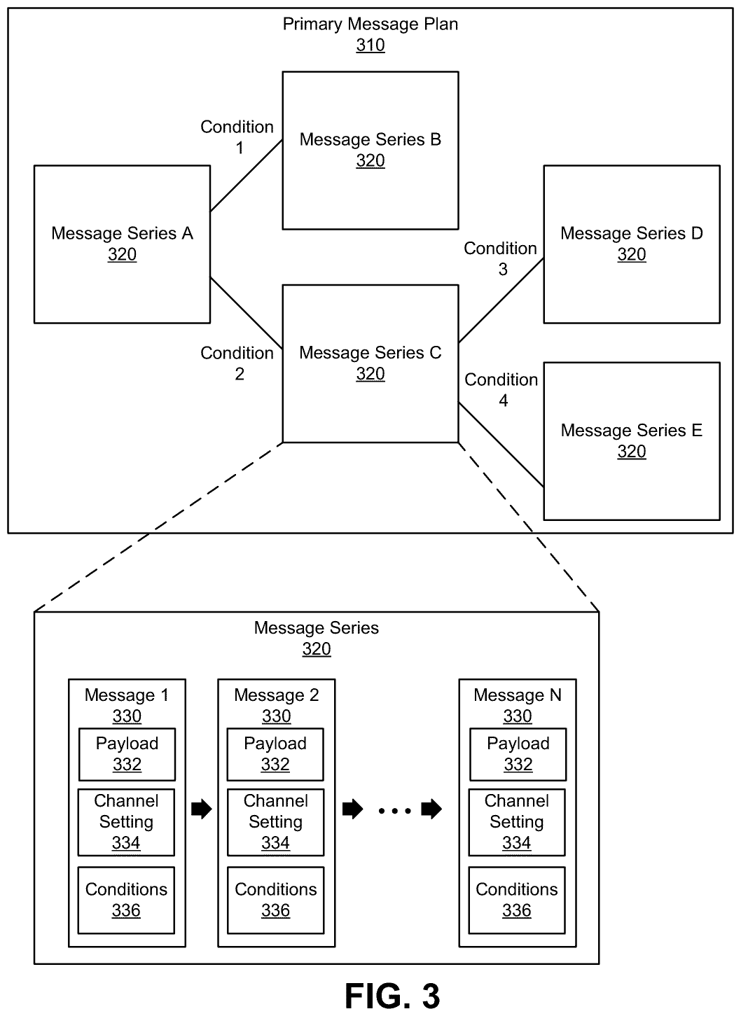

The message management server 110 may transmit messages to message recipients 130 via different channels 150. A channel 150 may be associated with a communication protocol or another non-standard method. A channel 150 may also be referred to as a communication channel. Examples of channels 150 include text messaging services (e.g., SMS, MMS), emails (e.g., mobile emails, plain text emails, browser emails), push notification protocols (e.g., APPLE push notification, ANDROID push notification), instant messaging applications (WHATSAPP, WECHAT, TELEGRAM), in-application messages (e.g., messages sent within application 134), social networking systems (e.g., FACEBOOK, TWITTER), RSS feeds, web browser notifications, other suitable protocols such as simply message payloads sent as an Internet packet or a series of packets. The message management server 110 may decide that a message is to be transmitted through one or more channels based on the setting provided by the message publisher 120. The details of the selection of channels will be discussed in further detail below with reference to FIGS. 2 and 3.

A channel 150 may or may not correspond to a user computing device 132. For certain types of channels 150, the user computing device 132 that will receive the message is fixed. For example, for an SMS message, the user computing device 132 that is associated with the phone number will receive the message. An in-app message may also be sent to the user computing device 132 with which the application 134 is installed. A message intended for an IoT device may also be sent using a channel 150 that is associated with the IoT device. Yet, in other cases, the user computing device 132 that is going to receive the message is not fixed. For example, a message recipient 130 may read an email message from more than one user computing device 132.

In some cases, a user computing device 132 may be installed with multiple applications 134 that have included the SDK 136 developed by the message management server 110. In such cases, the SDK 136 has a different channel identifier associated with each application 134. The in-app messages for different applications 134 are considered to be sent via different channels. In some embodiments, an in-app message to a message recipient 130 and the response of the recipient for a particular application 134 may be communicated through a specific application channel that does not cross talk with other in-app messages associated with different applications 134.

A model serving system 160 receives requests from the message management server 110 to perform inference tasks using machine learning models. The inference tasks include, but are not limited to, natural language processing (NLP) tasks, audio processing tasks, image processing tasks, video processing tasks, and the like. In one embodiment, the machine learning models deployed by the model serving system 160 are models configured to perform one or more NLP tasks. The NLP tasks include, but are not limited to, text generation, image generation, query processing, machine translation, chatbot applications, and the like. In one embodiment, the language model is configured as a transformer neural network architecture. Specifically, the transformer model is coupled to receive sequential data tokenized into a sequence of input tokens and generates a sequence of output tokens depending on the inference task to be performed.

The model serving system 160 receives a request including input data (e.g., text data, audio data, image data, or video data) and encodes the input data into a set of input tokens. The model serving system 160 applies the machine learning model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one embodiment, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the message management server 110 or entities/systems different from the message management server 110. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one embodiment, when the machine learning model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In one embodiment, the inference task for the model serving system 160 can primarily be based on reasoning and summarization of knowledge specific to the message management server 110, the message publisher 120, or the message recipient 130, rather than relying on general knowledge encoded in the weights of the machine learning model of the model serving system 160. Thus, one type of inference task may be to perform various types of queries on large amounts of data in an external corpus in conjunction with the machine learning model of the model serving system 160. For example, the inference task may be to perform question-answering, text summarization, text generation, and the like based on information contained in the external corpus.

Thus, in one embodiment, the message management system is connected to an interface system 170. The interface system 170 receives an external corpus of data from the message management server 110 and builds a structured index over the data using another machine learning language model or heuristics. The interface system 170 receives one or more task requests from the message management server 110 based on the external data. The interface system 170 constructs one or more prompts for input to the model serving system 160. A prompt may include the task request of the message recipient 130 and context obtained from the structured index of the external data. In one instance, the context in the prompt includes portions of the structured indices as contextual information for the query. The interface system 170 obtains one or more responses to the query from the model serving system 160 and synthesizes a response. While the message management server 110 can generate a prompt using the external data as context, oftentimes, the amount of information in the external data exceeds prompt size limitations configured by the machine learning language model. The interface system 170 can resolve prompt size limitations by generating a structured index of the data and offers data connectors to external data and provides a flexible connector to the external corpus.

In some embodiments, the message management server 110 uses a LLM to design a message series. A message series is a series of related messages that are sent to a message recipient 130 when a certain condition is met. A message series may be referred to as a payload series or staged payload delivery. A message series may be associated with a start condition, an end condition, message recipient selection criteria, a message order, message branching, and trigger conditions and channels 150 to be used for each message in the series. The message management server 110 receives, from a message publisher 120, input describing a message series. The input may include information about the structure of the message series (e.g., start and end conditions, channels to use for each message, trigger conditions, number of messages etc.) or information about the content of each message (e.g., context of the message, tone of the message, keywords to include or exclude, etc.). The message management server 110 may receive the input as free form input, for example “I want a message series to announce a new ice cream flavor. The tone of the messages should be playful, say “summer,” and exclude “sugar.” Create three messages to send via email within the span of a week before the flavor comes out.” The message management server 110 may alternatively receive the input as selection from a drop-down menu, for example a selection of the tone “playful” from a list “playful, serious, heartfelt, sad, uplifting, urgent.” The message management server 110 may generate a prompt for a LLM based on the received input and provide the prompt to the LLM for execution. The message series management engine 225 receives a response from the LLM that includes messages to use in the series.

In some embodiments, the message management server 110 may use a text-to-image generation model to generate images for use in messages of the message series. The message management server 110 may receive input from message publishers 120 describing images to be used in a message series. For example, the message management server 110 may receive input like, “In the first message of the series, include an image of an ice cream cone filled with pink swirled ice cream.” The message management server 110 may generate a prompt for the text-to-image generation model based on the received input. Alternatively, the message management server 110 may generate a prompt for the text-to-image generation model from the text of messages in the series, for example the text of messages output by the LLM.

In some embodiments, the message management server 110 automatically determines an action to be taken and automatically performs the action. The message management server 110 automatically determines and performs the action based on the content of the message or other contextual information, such as data associated with the message publisher 120 or the message recipient 130. The message management server 110 may provide one or more messages or responses between the message recipient 130 and the message publisher 120 to the model serving system 160 and/or the interface system 170. The message management server 110 may receive a response for each message that indicates the action to be performed for the message. In some cases, the desired action may be an activity performed by the message management server, (e.g., creating a purchase order, canceling a subscription, making a purchase, generating a statement, performing a customer service, issuing or reissuing a mobile pass, etc.).

In some embodiments, the responses from the LLM are determined based on previous chat history across different message recipients 130 and message publishers 120 to infer common interactions that previously resulted in certain actions being performed as a response. Specifically, in one embodiment, the message management server 110 provides the model interface system 170 with a collected history of previous chats between message recipients 130 and message publishers 120 that provide insight into what types of desired actions can be performed to respond to a message. The message management server 110 provides the messages of a conversation to the interface system 170 such that the interface system 170 constructs the appropriate prompts to the model serving system 160 based on the database of previous chat histories. In other instances, the message management server 110 provides the messages of a conversation directly to the model serving system 160 with a generated prompt that includes the message and contextual information about previous chat histories.

In one embodiment, the message management system 110 maintains a set of rule actions which are categories of actions that can automatically be invoked in response to a message. For example, the rule actions may include automatically responding to the message in the conversation. Responsive to determining a desired action from the response of the LLM, the message management server 110 determines whether an appropriate rule action (e.g., upgrade economy flight ticket to first class flight ticket) that corresponds to the desired action exists. If the rule action exists, the message management server 110 invokes the desired action (e.g., upgrade customer's flight) and automatically sends a notification message (e.g., “I have upgraded you to first class”) to the message recipient 130.

In this manner, the message management server 110 automatically responds to conversations on behalf of the receiving party. This allows the message management system 110 to eliminate human interaction when responding to action-oriented messages, allowing for automated and efficient processing of customer orders.

### Example Message Management Server Components

FIG. 2 is a block diagram illustrating various components of an example message management server 110, in accordance with some embodiments. A message management server 110 may include a message publisher management engine 205, a message recipient management engine 210, an event management engine 215, an orchestration strategy management engine 220, a message series management engine 225, a message campaign management engine 230, an automated action engine 233, an analytics management engine 235, a channel selection engine 240, a message transmission engine 245, a front-end interface engine 250, and a machine learning training engine 255. In various embodiments, the message management server 110 may include fewer or additional components. The message management server 110 also may include different components. The functions of various components in message management server 110 may be distributed in a different manner than described below. Moreover, while each of the components in FIG. 2 may be described in a singular form, the components may present in plurality.

The components of the message management server 110 may be embodied as software engines that include code (e.g., program code comprised of instructions, machine code, etc.) that is stored on an electronic medium (e.g., memory and/or disk) and executable by a processing system (e.g., one or more processors and/or controllers). The components also could be embodied in hardware, e.g., field-programmable gate arrays (FPGAs) and/or application-specific integrated circuits (ASICs), that may include circuits alone or circuits in combination with firmware and/or software. Each component in FIG. 2 may be a combination of software code instructions and hardware such as one or more processors that execute the code instructions to perform various processes. Each component in FIG. 2 may include all or part of the example structure and configuration of the computing machine described in FIG. 9.

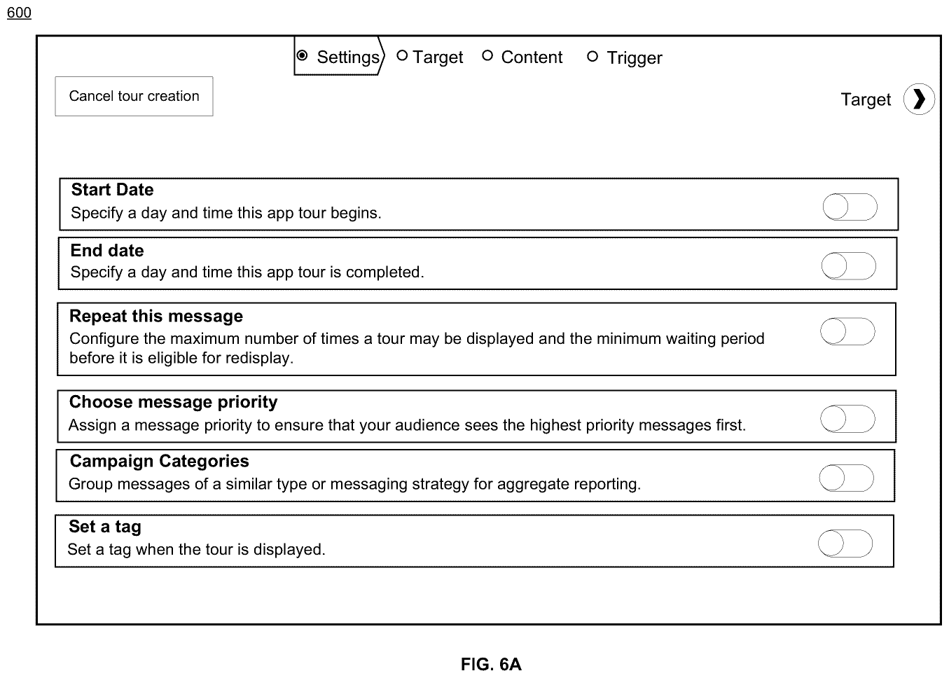

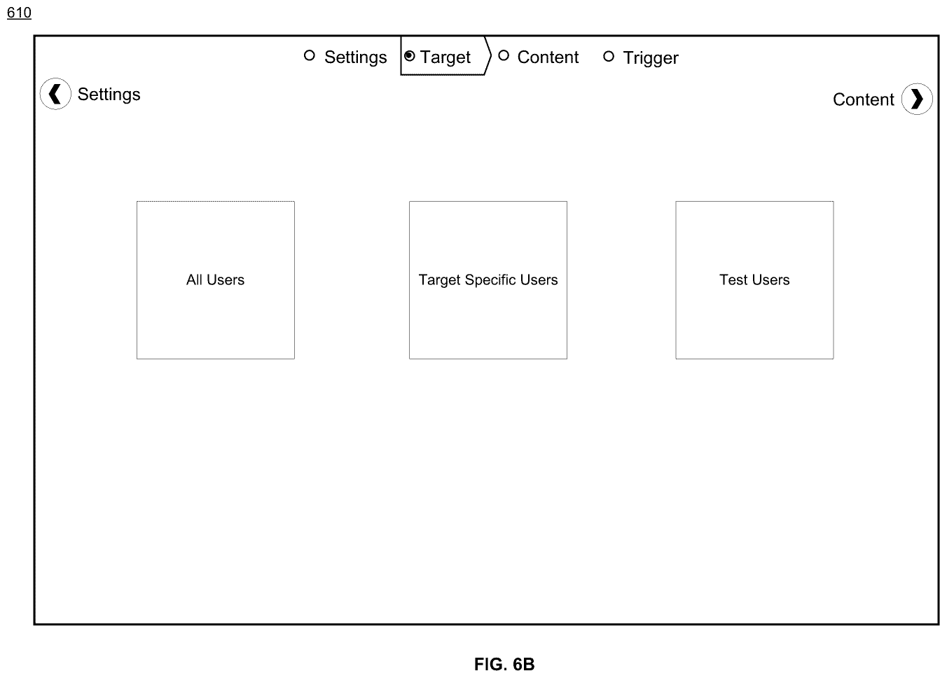

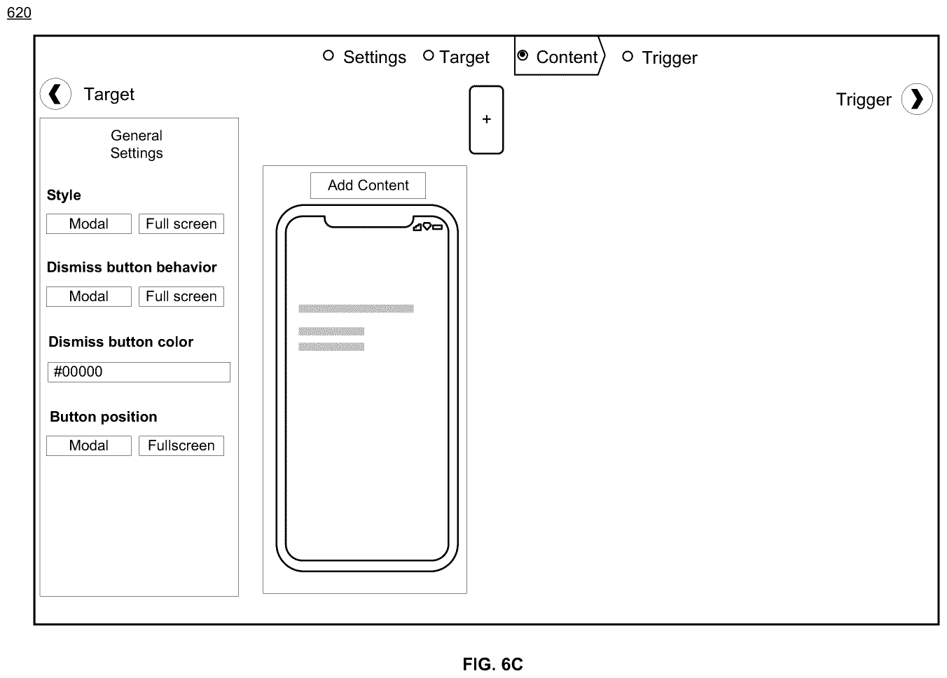

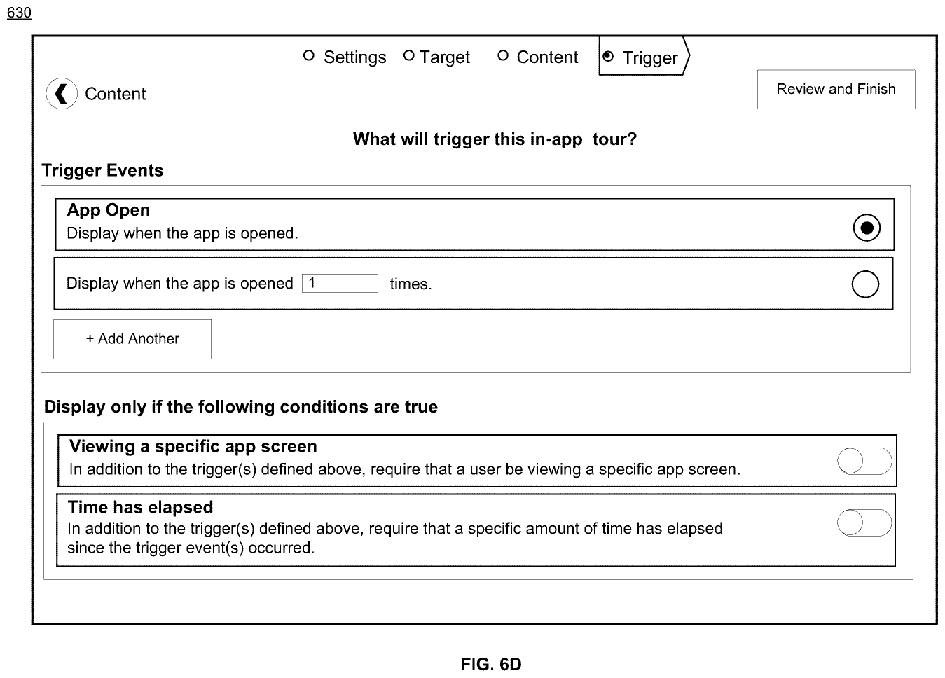

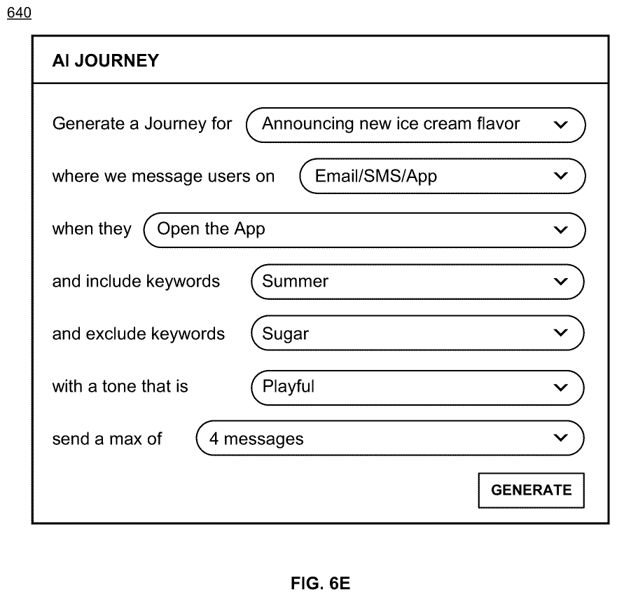

The message publisher management engine 205 manages the profiles and credentials of message publishers 120 and stores saved templates and saved messages for the retrieval of the message publishers 120. For example, a customer that intends to use the message publisher management engine 205 to launch a message campaign to distribute messages to various end users may create an account with the message management server 110. The message management server 110 stores the customer's profile, metadata, credential and associate the information with a unique customer identifier, such as publisherID. The customer (an example of a message publisher 120) may create message templates, message series templates, digital pass templates (e.g., digital boarding passes and digital coupons), specify criteria of message distribution and goals of message campaigns, select or specify types of events and analytics to be captured by the message management server 110, and configure other settings with the message management server 110. The templates and settings are associated with the customer identifier and can be retrieved, duplicated, edited, and deleted based on the message publisher's preferences and actions entered through a message management application and/or API provided by the message management server 110. The message management application also may enable (or provide for display) one or more graphical user interfaces (GUIs) for rendering on, for example, a user computing device 132. Examples of GUIs of the message management application will be discussed in further detail with reference to FIGS. 6A-E and 7A-B.

By way of example, the message publisher management engine 205 may include a message publisher profile database, which may also store information including filter preferences, event types, message publisher server destination, and predictive and automation settings for registered users. In other embodiments, the message publisher account database may also store additional services that a message publisher 120 would like to interface with, including the number of active streams associated with the message publisher 120. For example, these additional services can be other message publishers and/or strategic partners. Continuing with the example, a message publisher 120 may optionally choose to create three active streams. One stream may be associated with a server configured to receive a stream generated associated with a message publisher 120 at a specific server destination, e.g., www.foo.com, another with a server associated with a social media system, e.g., FACEBOOK, TWITTER, PINTEREST, etc., and the last with a server associated with a message publisher organization. In some example cases, the preferences associated with a message publisher profile may be a username and/or destination address. The message management server 110 may also be configured to accept additional message publisher preferences. This additional message publisher information may capture targeted demographics information, spending habits, travel habits, and other such details.

In some embodiments, the message publisher management engine 205 may also store credentials or access keys of message publishers 120. The message publisher 120 may provide the message management server 110 an access key, such as an API access key with a particular level of access privilege, for the message management server 110 to query the third-party system to retrieve information of the end users.

The message recipient management engine 210 manages the message recipients 130 to whom the messages are sent. A message publisher 120 may specify a set of intended message recipients 130. A message recipient 130 may be associated with a recipient identifier, recipientID. Depending on whether a message recipient 130 is identified as possessing a user computing device 132, applications 134, and/or SDK 136, the message recipient management engine 210 may also associate the recipientID with one or more of a device identifier, application identifier (which may be in the form of channel identifier), and SDK identifier. For example, each user computing device 132 associated with the message recipient 130 may be associated with a device identifier, deviceID. For some devices, the message recipient management engine 210 may also store application identifier, applicationID, for identifying actions occurred at or related to an application 134 and track in-app messages sent through the application 134. A set of recipientIDs, deviceIDs, and applicationIDs may be associated with a publisherID.

The message recipient management engine 210 may maintain metadata tags for message recipients 130. For metadata tags may include information such as whether a recipient is a natural person or not, preferences of the message recipients 130, opt-in or opt-out options of the message recipients 130 (e.g., a message recipient may opt-out for receiving a message from a particular channel), and other characteristics of the message recipients, including consented information such as gender, age, interested products, interested news, etc. Based on the characteristics of the message recipients 130, the message recipient management engine 210 may categorize the message recipients into one or more groups. The message recipient management engine 210 may also store records of messages sent to each message recipient 130, such as metadata of the messages (e.g., date and time of the messages, the channel identifier, channelID, used to send a particular message), the payloads of the messages, actions taken or related to each sent message, and types of devices and deviceIDs to which the message are sent.

The event management engine 215 manages and stores events associated with message recipients 130, user computing devices 132, or applications 134. The events may be transmitted from the message publishers 120, from third parties, or from the user computing devices 132.

Events transmitted from the message publishers 120 or third parties may trigger a distribution of one or more messages by the message management server 110 to different message recipients 130. By way of example, a message publisher 120 may be an airline that transmits an event notification to the message management server 110 that a flight is delayed and identifies the passengers of the flight based on the recipientIDs. Based on the event notification, the message management server 110 may send a message to the passengers. In another example, a message publisher 120 may be a bank that sends an event notification to the message management server 110 that an end user has settled a transaction. Based on the event notification, the message management server 110 sends a confirmation message to the end user. In yet another example, the event may be transmitted from a third party. The message management server 110 may identify message recipients 130 that are potentially affected by the event notified by the third party.

The events may also be sent from various user computing devices 132 associated with message recipients 130. Those event notifications may be referred to as mobile event notifications. Each mobile event notification may be associated with a message recipient 130 and be saved along with an event identifier, eventID, a messageID and a recipientID. Mobile event notifications may be transmitted from mobile event sources. In various embodiments, a mobile event source may be an IoT device or a user computing device 132 running an application 134. The application 134 is configured to generate and transmit a mobile event notification. For example, the SDK 136 may include code instructions to cause a user computing device 132 to collect information describing an occurrence of an event and/or transmit a mobile event notification corresponding to the occurrence of the event to the message management server 110. A mobile event notification may be related to a user computing device 132 or may be specific to a particular application 134 that is in communication with the SDK 136.

A mobile event notification from a user computing device 132 may include a notification payload and a destination associated with a message publisher 120. In various embodiments, the destination is a network address such as a message publisher computer, a proxy server, or another device configured to receive data streams from message management server 110. For example, the destination may be a specified universal resource locator (URL), e.g., “www.message publisher.com/proxyserver”. The notification payload associated with a mobile event notification, received by message management server 110, may include an event descriptor and a notification identifier.

The event descriptor may include at least one of an application lifecycle event, a user engagement event, a user behavior event, a user insight event, a user location event, or any combination thereof. In one example, an event descriptor is an application lifecycle event such as a “first open” of an application 134, an “inactivity” event (e.g., an application 134 has been inactive), an “app open” event, an “app close” event, or an “app uninstall” event; a user engagement event such as a “push”, a “push send”, a “rich deliver”, a “rich read”, a “rich delete”, an “in application display”, a “digital pass object install” or a “digital pass object remove”; a user behavior event such as a “tag update” event, an “app open” event, an “app close” event, or other custom events defined by a message publisher 120. In some embodiments, the event descriptor may also include a user location event such as geolocation, or timestamp data or a user insight event associated with a prediction of a future application lifecycle event, user engagement event, user behavior event, user location event, or any combination thereof. For the ease of reference, all those events, whether they are related to application lifecycle, user engagement, location, or timestamp, may be collectively referred to application lifecycle events.

By way of example of a mobile event notification, a user computing device 132 (e.g., a mobile phone, an IoT device) sends a mobile event notification to message management server 110 if the user computing device 132 is within a threshold distance of a store of a message publisher 120, or if the user opens the application 134 or interacts with an IoT device.

A notification identifier may include an identification of the notification and other identification information. For example, the identification may include a userID, an applicationID, a message publisherID, a deviceID, deviceType, or any combination thereof. For example, a mobile event notification generated by a user computing device 132 associated with a user “Nolan” may include a message that a user associated with userID: “Nolan”, a deviceID: “02”, an event descriptor: “app uninstall” associated with a message publisherID: LATTE, INC., at Time: 11:00 PM PST near a location of 123 Main Street, Portland, Oregon.

In some embodiments, a mobile event source is an IoT device associated with a message publisher 120. An IoT device may be configured to transmit a mobile event notification to message management server 110. For example, an IoT device may be a temperature sensor that generates a mobile event notification with the current temperature and transmits the generated mobile event notification to the message management server 110 via network 145.

In some embodiments, upon receiving a mobile event notification from a user computing device 132, the event management engine 215 generates a mobile event token. The mobile event token may be derived (e.g., a hash) in some way from the received mobile event notification and/or metadata relating thereto. In some embodiments, a single mobile event token is assigned to a plurality of received mobile event notifications. Additionally, as used herein, the process of generating a mobile event token from a mobile event notification may be referred to as “decorating a received mobile event notification” and can be used to provide context to mobile event notifications received from a user computing device 132.

In some embodiments, the event management engine 215 may generate the mobile event token by communicating with a number of contextual services. The event management engine 215 may include code segments for generating a mobile event token including assigning context obtained from one or more contextual services. Contextual services may further include any number of modules that extract timestamp data, demographic data associated with a user, GPS data, historical data including historical trends, or any combination thereof from a received mobile event notification. For example, upon receiving a mobile event notification associated with an “app open” event from a user computing device 132, the event management engine 215 generates a mobile event token including a timestamp and a GPS location associated with the received event. In other embodiments, the contextual data assigned to a mobile event token associated with a mobile event notification may be associated with a certain user computing device 132 including one or more identifiers. In still other embodiments, the message management server 110 may decorate a mobile event token with a predicted user behavior including a future user engagement event, an application lifecycle event, or any combination thereof. U.S. Pat. No. 10,567,536, entitled “Mobile Event Notification for Network Enabled Objects,” patented on Feb. 18, 2020, is hereby incorporated by reference for all purposes.

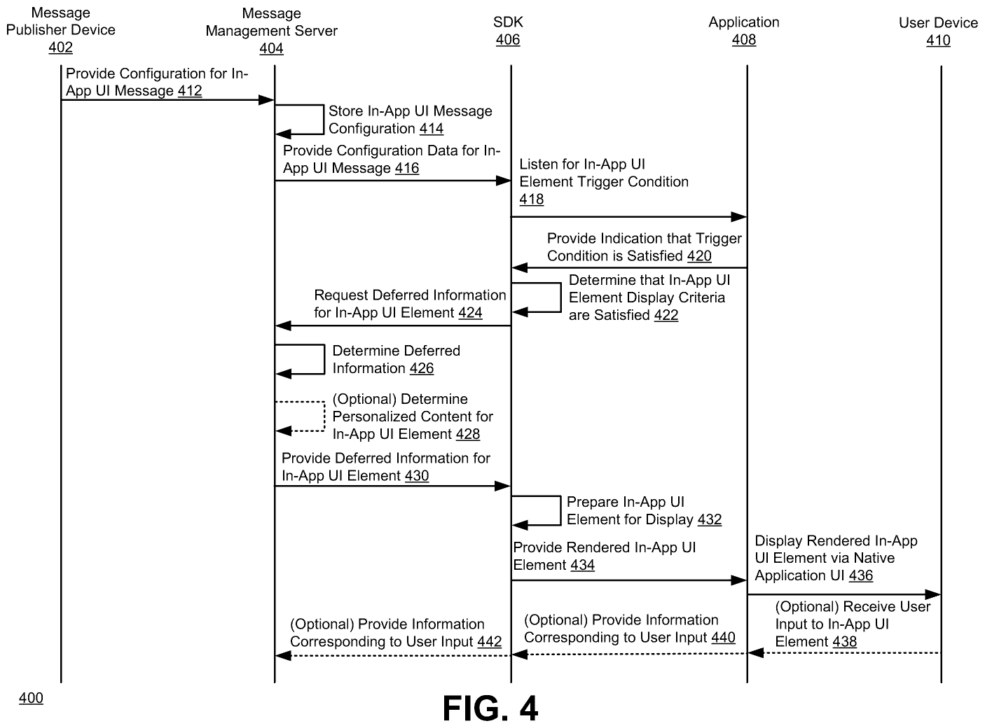

In some embodiments, the SDK 136 maintains a set of active in-app UI elements intended for display in the application 134 in response to mobile event-related trigger conditions being met. The SDK 136 may receive in-app UI element messages from the message management server 110 including configuration data for active in-app UI elements including one or more trigger conditions from the message management server 110. In this case, the SDK 136 may update the set of active in-app UI elements based on the received configuration data and/or configure listeners for mobile event notifications corresponding to the one or more trigger conditions. If the SDK 136 determines that the one or more trigger conditions are met, the SDK 136 may communicate with the one or both of the application 134 or the message management server 110 in order to render the in-app UI element for display in the application 134. Embodiments of operations performed by the SDK 136 for rendering in-app UI elements are described in greater detail below with reference to FIG. 4.

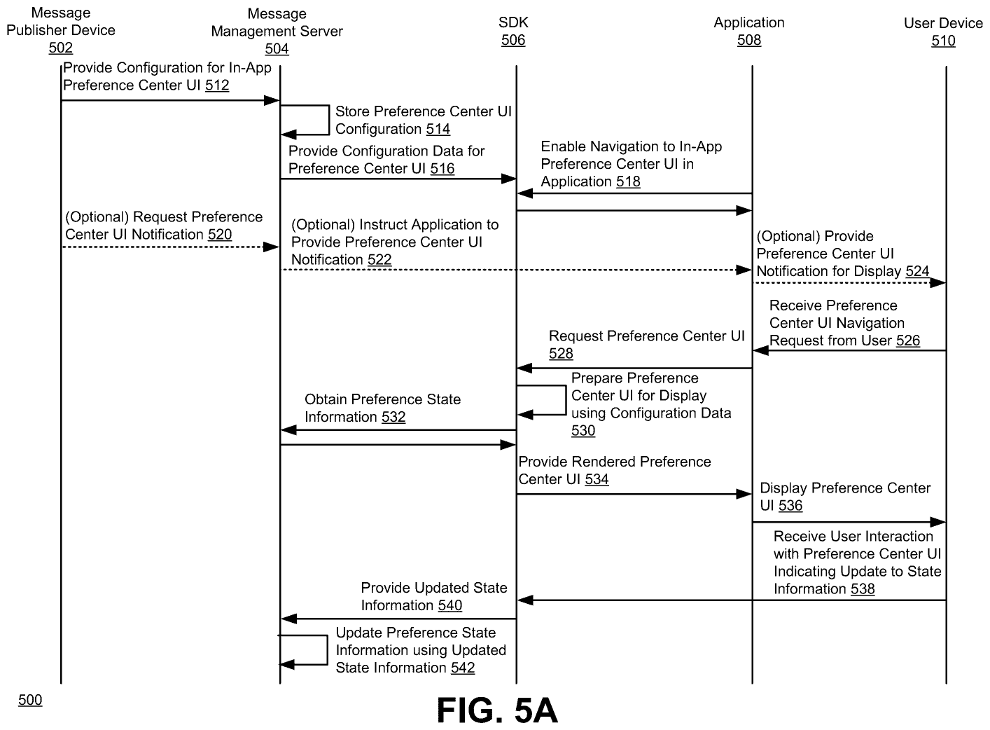

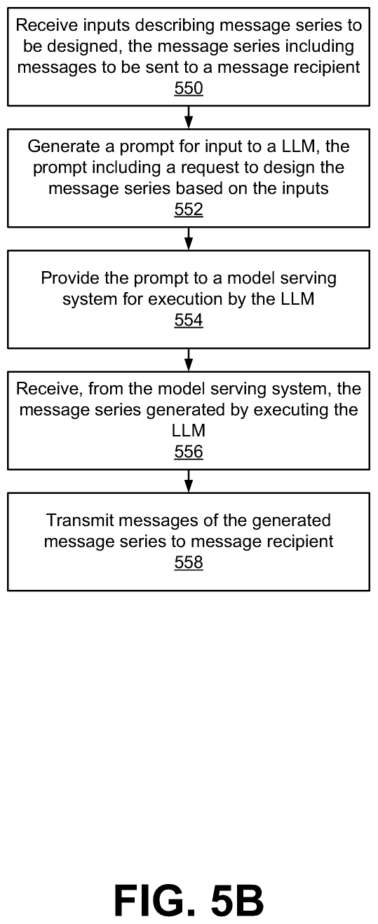

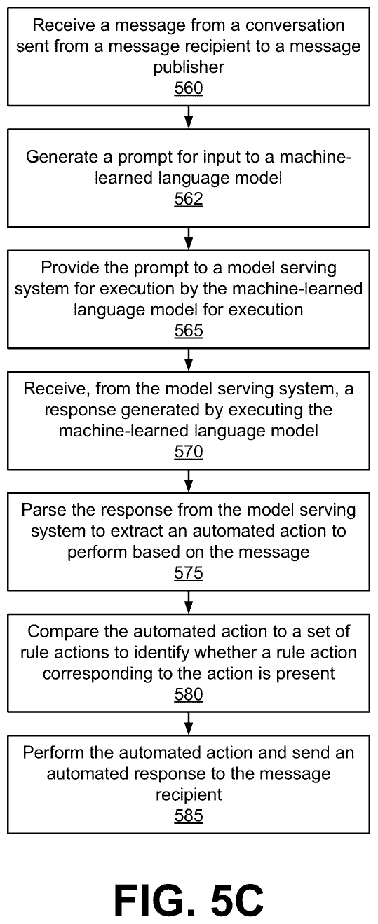

In some embodiments, the SDK 136 maintains in-app dynamic preference center UIs for display in the application 134. Similarly to active in-app UI elements described above, the SDK 136 may receive configurations for in-app preference center UIs from the message management server 110. Preference center UI configurations describe in-app UI elements that facilitate user configuration of various user preferences (e.g., app settings). Preferences may correspond to user preferences for operations performed by the message management server 110, such as what types or through what channels a user computing device 132 or application 134 receives from the message management server 110. Additionally, or alternatively, preferences may correspond to user preferences for the application 134. The SDK 136 may embed a mechanism for navigating to an in-app preference center UI corresponding to a preference center UI message received from the message management server 110, such as a button or other interactable UI element. Additionally, or alternatively, the SDK 136 may receive notifications messages from the message management server 110 through one or more channels external to the application 136 (e.g., a push notification, an email, a text message, etc.) including a deep link to an in-app preference center UI. Embodiments of operations performed by the SDK 136 for rendering in-app preference center UIs are described in greater detail below with reference to FIG. 5A.

The orchestration strategy management engine 220 stores strategies and rules provided by message publishers 120 for the transmission of messages to various message recipients 130. In some message campaigns, the same message may be sent to a message recipient 130 through multiple channels 150 or a series of related messages may be sent to the message recipient 130 through different channels 150. The transmission of messages through different channels 150 may be referred to as channel orchestration. For example, a message publisher 120 may set up a message series for a payment reminder. The first reminder message may be sent through a less disruptive channel 150 such as by an email. Subsequent reminder messages may be sent through more disruptive channels 150 such as a publish notification, an in-app notification, and an SMS message.

The orchestration strategy management engine 220 may allow a message publisher 120 to pick different channel selection rules for each message or a series of messages. Example channel selection rules may include channel priority with fall back, last active, originating channel, and fan out option. When the message management server 110 sends a message to a message recipient 130, the message management server 110 selects one or more channels 150 based on the channel selection rules associated with the message.

A channel selection rule for channel priority with fall back allows a message publisher 120 to select the priority of the channels to send a message and select fall back channels if a higher-priority channel(s) is not available. A channel selection rule may be applicable to a large group of message recipients 130. The message recipient management engine 210 may provide a list of available channels 150 (e.g., channels that are opted in, or not opted out) for each intended message recipient 130. Each intended message recipient 130 may be associated with a different list of available channels 150. The message management server 110 attempts to send the message to the highest priority channel first and falls back to alternative channels if a message recipient 130 does not opt in for the highest priority channel.

The channel selection rule for the last active channel or the originating channel specifies that the message management server 110 sends a message based on the message recipient's last active channel or the originating channel. The event management engine 215 may provide mobile event notifications that include information on whether a user has taken an action (e.g., opening a message, responding to an email, etc.) with respect to a channel 150. If the user takes an action that triggers the message management server 110 to send another message, the new message may be sent to the same channel. This reaction by the message management server 110 may be selected by the originating channel selection rule. The originating channel selection rule may also specify that the message management server 110 to target a channel 150 associated with a trigger event. For example, the message publisher 120 may direct the message management server 110 to send a message when a trigger event is detected from a channel 150 or associated with an application related to a channel 150. For example, a message publisher 120 may specify that a new message is to be sent when a location event is detected (e.g., a device enter a radius or a territory of a location). The location event may be sent from an application 134. The message management server 110 may send the new message through an in-app message or a push notification associated with the application 134.

The channel selection rule for fan-out specifies that the message management server 110 to send the same message to a message recipient 130 through multiple channels 150 simultaneously or within a reasonable timeframe. A message publisher 120 may select multiple channels 150 for the fan-out option. For a specific message recipient 130, the message management server 110 sends the message through various channels 150 unless one or more channels are opted-out by the message recipient 130.

The message series management engine 225 allows message publishers 120 to design a message series. Each message series may be referred to as a journey. A message series may include a series of related messages that are sent to a message recipient 130 when a certain condition is met. A message series may be associated with a start condition, an end condition, message recipient selection criteria, a message order, message branching, and trigger conditions and channels 150 to be used for each message in the series. The message series management engine 225 manages the message series that are designed and saved by various message publishers 120.

A start condition may include various rules that specify when a message series will be triggered for a particular candidate message recipient 130. A trigger condition may be an event, such as a mobile event when the message management server 110 receives a mobile event notification. For example, a message series may be triggered when a user first opens the application 134. A trigger condition may also be another event whose notification is provided by the message publisher 120 or a third party. For example, a message series may begin 24 hours after a user has created an account with the message publisher 120. Other trigger condition may include tag change, inactivity, first seen, location matching, location attributes, and an event occurring. The start condition may also include timing and date for the first message in the message series to be sent after a trigger condition is met. In some cases, the message series starts immediately after a trigger condition is met. In other cases, the message series is scheduled based on the timing and date. The start condition may also include certain limitations. For example, the limitation may prevent the message management server 110 from involving a message recipient 130 in more than a certain number of message journeys within a predetermined period of time. The limitation may also prevent the message management server 110 from involving a message recipient 130 in a repeated message journey. A trigger condition may also be a risk factor such as a churn risk associated with an application 134 or a channel 150.

An end condition may include various rules that specify when a message series is completed. A message publisher 120 may specify that a message series is completed after all messages in the series are sent. Other end condition examples may specify rules for a message series to end prematurely. For example, a message series may end on a bn event or a cancellation event. A conversion event is associated with a conversion condition. The message management server 110 may exit a message recipient 130 when the conversion event is detected. For example, in a marketing campaign, when a message recipient 130 clicks on an advertisement that is sent as a message, the message publisher 120 may specify that the clicking of the advertisement is a successful conversion. In another example, if the message series is for reminding a user to make a monthly payment, the conversion event may be that the user has made the monthly payment. A cancellation event may be an event that is indicated by the message recipient 130 or the message publisher 120 to stop the message series when the cancellation event is detected. For example, a message recipient 130 may want to opt-out or unsubscribe from the message series. The message recipient selection criteria allow a message publisher 120 to select what users will be selected for a particular message series. The selection criteria could be event-based, metadata tag-based, device-type-based, channel-based, or any combination thereof.

The message order and message branching allow a message publisher 120 to select how the messages in a series are arranged. A message series can be linear or can be branched. The message publisher 120 may also specify conditions to skip one or more messages.

The trigger conditions and channels 150 to be used for each message in the series are rules that are specified by a message publisher 120 indicating conditions for how or when a message will be provided to a user via one of the channels 150. For example, a trigger condition for a message may define conditions that to be met for the message to be transmitted by the message management server 110 via a channel of the channels 150. As another example, a trigger condition for a message may define conditions to be met for the SDK 136 to provide a message to a user of the user computing device 132, such as by displaying an in-app UI or UI element. The trigger condition for a message may be time-based. For example, a second message may be sent 2 days after the first message is sent. The trigger condition for a message may also be event-based, such as when the message management server 110 receives a mobile event notification that matches the trigger condition. The event-based trigger condition may also include a time element such as a delay after the event condition is met. Other trigger conditions discussed in this disclosure are also possible. For each message, a message publisher 120 may also select a channel selection rule based on the discussion above with reference to the orchestration strategy management engine 220.

In some embodiments, a message series may include one or more in-app UI messages, other types of messages, or some combination thereof. For example, a first in-app UI element corresponding to a first in-app UI message in a message series may facilitate access to a second in-app UI element (e.g., via a user interaction) corresponding to a second in-app UI message in the message series. In cases where the message series includes one or more in-app UI messages, the message management server 110 or the SDK 136 may evaluate the start or end conditions for the individual in-app UI messages relative to other in-app UI messages in the message series. For instance, the SDK 136 may begin listening for one or more start conditions for a second in-app UI message after a first in-app UI message in the message series has been triggered.

In some embodiments, a message publisher 120 may design a message series that is a two-way messaging series. In one of the trigger conditions in the series, the condition options may include no response from the message recipient 130 and various types of responses from the message recipient 130. When no response is received, the message management server 110 may allow the message publisher 120 to specify that another message is to be sent, which is to be sent by the same channel or by a different channel. This allows the message series to attract the message recipient 130 to re-engage in the message series. If a response is received, the message management server 110 parses the response and determines the action to be taken based on the response. The action may be drafting or sending another message to the recipient 130. The action may be an activity to be performed by the message management server 110, such as creating a purchase order, canceling a subscription, making a purchase, generating a statement, performing a customer service, issuing or reissuing a mobile pass, etc.

To analyze the response, the message management server 110 may parse the response in various ways. In some embodiments, the message management server 110 may analyze the string pattern and search for keywords in the response. For example, the message management server 110 may search for keyword that represents the message recipient 130 authorizing an action (e.g., making a purchase). The message management server 110 may also look for keywords such as quantity, item name, object name, and named entity in the response. In some embodiments, the message management server 110 may also employ one or more natural language processing technique to analyze the response. In some cases, the response may also include authentication keyword such as a PIN or a password from the message recipient that authorizes a certain transaction. For example, in a message series, the message management server 110 may send an offer of an item on behalf of a message publisher 120 to an end user. The end user may provide an in-app response to the message to authorize a purchase. The message management server 110 may complete the in-app purchase upon proper authentication and authorization procedures. In some embodiments, the message management server 110 may use the model serving system 160 to automatically determine the action to be taken from the response and perform the action (see the automated action engine 233).

In some embodiments, the message series management engine 225 may design a message series using a LLM. The message series management engine 225 may provide a message publisher 120 with a user interface that allows the message publisher to provide input related to the message series. For example, the message series management engine 225 may provide a message publisher with the GUI of FIG. 6E. The message series management engine 225 may receive the input as free form input, as selections from a drop-down menu, or otherwise. The message series management engine 225 may receive input describing the content of the messages in the series. For example, the message series management engine 225 may receive input to design messages with an uplifting tone, that include the keyword “sentimental” and exclude the keyword “cheap.” The message series management engine 225 may receive input describing the structure of the message series. For example, the message series management engine 225 may receive input to design a message series including three messages to be sent over an email channel. The message series management engine 255 generates a prompt for a LLM based on the received input. For example, the message series management engine 225 may generate the prompt:
“Design a series of three email messages describing a wedding invitation service. Make the messages uplifting in tone and include the word “sentimental” but exclude the word “cheap.””
   The message series management engine 225 receives a response from the LLM that includes messages to use in the series. Training of an LLM for the above described purposes is described with respect to the machine learning training engine 255.

The message campaign management engine 230 manages message campaigns designed by various message publishers 120. A message campaign may be a goal-based collection of multiple related message series. For example, a message publisher 120 may design a goal-to-goal branching of multiple message series. Each message series may have a goal that is specified in the end condition of message series. The message series are linked together in any suitable ways, branched or linear, cyclic or acyclic. A message campaign may also be referred to as a primary message plan.

The selection of message series in a message campaign may depend on the recipient's response in one or more two-way message series. For example, in a re-engagement campaign, the message management server 110 may determine that the recipient did not provide a response to messages that are sent in one of series. A chunk model may be to determine a threshold level of whether a particular end user has churned with respect to the usage of an application 134. In turn, the message management server 110 may select message series that include communications in other channels to attract the end user to re-engage with the application 134. In another example, an end user may provide a response in a two-way messaging series. Based on the type of response and the goal specified by the message publisher 120 when designing the message campaign, the message management server 110 may select different subsequent message series to be sent to the recipient 130.

In some embodiments, the message management server 110 may automatically determine the action to be taken based on the response or may automatically draft and send a message to be sent as part of a message series (e.g., instead of using the message campaign management engine 230 to select a previously drafted or saved message). To do so, the automated action engine 233 retrieves messages occurring between the message recipient 130 and the message publisher 120 or message management server 110 and determines whether a message sent by the message recipient 130 can be automatically processed. Specifically, the automated action engine 233 may continuously monitor and retrieve messages between the message recipient and the message publisher 120 or message management server 110.

The automated action engine 233 constructs a prompt and a task request to the LLM on whether an automated response can be generated for the message. An example prompt to the LLM of the model serving system 160 may be:
“Given [current chat history], what is a response to the message “when does my flight board?” if any?”

The message management server 110 may receive a response from the LLM that may be:
“The flight boards at 11:20 am EST.”

The automated action engine 233 may provide the response back to the message series management engine 225 such that an automated message can be sent to the message recipient 130 without manual involvement by the message publisher 120. The content associated with the response (e.g., the time of 11:20 am EST) may be obtained from prior chat history where the content was previously mentioned (e.g., in a prior chat message where the boarding pass was previously provided to the message recipient 130).

In one embodiment, given a response from the LLM, the automated action engine 233 obtains a confidence level of the response from the LLM. If the confidence level of the response is above a threshold value, then the automated action engine 233 sends an automated message to the message recipient 130. In one instance, the confidence level is determined by comparing the response to previous responses of similar messages or requests, comparing for synonymous text, tone, context, and the like. In one instance, the confidence level can be determined by applying a machine learning model to the response, where parameters of the machine learning model can be trained based on training data including the previous responses.

As described in conjunction with FIG. 1, in one embodiment, the responses from the LLM are determined based on previous chat history across different message recipients 130 and message publishers 120 to infer common types of interactions. Specifically, in one embodiment, the automated action engine 233 may provide the model interface server 160 with a collected history of previous communications (e.g., records of messages) between message recipients 130 and message publishers 120 obtained from message recipient management engine 210. The communication information can be used to provide external data or context to the LLM that provides insight into what types of desired actions can be performed to respond to a message.

In some embodiments, for a given message series, the automated action engine 233 may also provide the model serving system 160 and/or the interface system 170 with a collected history of previous communications of the individual message publisher 120 or individual message recipient 130. In this manner, the LLM can generate automated responses to messages that mimic the individual message recipient 130′s or individual message publisher 120′s prior and future interactions in the interest of making the automated interactions more seamless.

In some embodiments, the automated action engine 233 may provide the model serving system 160 and/or the interface system 170 with additional data that may be used as inputs to one or more models. The automated action engine 233 may provide data associated with message recipients from the message recipient management engine 210 (e.g., metadata tags, characteristics of message recipients). The automated action engine 233 may provide data associated with the message publisher from the message publisher profile database of the message publisher management engine 205. The automated action engine 233 may provide data on events stored by the event management engine 215. The automated action engine 233 may provide data stored by the orchestration strategy management engine 220 that contains rules and strategies provided by message publishers 120 for the transmission of messages to various message recipients 130.

In one instance, the automated action engine 233 maintains a set of rule actions which can be invoked in the case that an action is to be performed for a message. Thus, the set of rule actions represents a set of categories of actions that are approved or allowed by the message publisher 120 for automatic invocation as a response to a message. For example, a rule action may be to respond to the message recipient 130 with known information (e.g., flight boarding time). In one instance, the set of rule actions maintained by the automated action engine 233 may also be obtained or identified from settings designed by the message publisher, previous communications between the message recipient 130 and the message publisher 120, or other appropriate data sources.

Responsive to identifying a desired action from the response of the LLM, the automated action engine 233 determines whether a rule action for the request exists, and invokes the identified action if a corresponding rule action is present for the identified action. The automated action engine 233 may also generate a message notifying the sending party of an automated response and/or that an action has been performed. The automated message may be sent to the message series management engine 225 such that the message is sent as a response to the message recipient 130 via a channel 150.

In one embodiment, the automated action engine 233 tracks whether the response from the LLM for one or more messages are missing a desired action and/or have identified a desired action but that desired action is missing from the set of rule actions maintained by the automated action engine 233. In such an embodiment, the LLM or the automated action engine 233 collects messages or requests with similar actions, and updates scores for each group of missing actions based on their frequency of invocation. If the score of the missing action is above a threshold value, the administrators of the automated action engine 233 may determine whether to add such an action to the list of rule actions, such that the action can be also automated in the future.

The analytics management engine 235 provides statistics and analytics for messages, message series and message campaigns. After messages are sent to message recipients 130, the message management server 110 may receive responses from the message recipients 130, mobile event notifications, or other notifications related to the messages. For some of the messages, the message management server 110 may also receive no action from the recipients or any notification at all. A message management server 110 may keep track of the number of users in each message series, actions taken by the users (or inactions) after receiving messages, and other metrics such as rates of meeting certain trigger criteria. A message publisher 120 may start a message series or a message campaign in real-time. The message management server 110 may display how many users (message recipients 130) are in each message series and other live analytics in real-time for each message or each message series as a summary of the progress of each message series. The analytics management engine 235 may also provide statistics related to commercial activities in a message series. For example, in a two-way message series, recipients 130 may make various in-app purchases. The analytics management engine 235 may provide conversion rate of the message series for messages sent that resulted in one or more purchases.

The channel selection engine 240 selects one or more channels 150 for transmitting or distributing a message. The channel section engine 240 may select the channels 150 based on the channel selection rules specified by the message publisher 120 as discussed in the orchestration strategy management engine 220. The channel selection engine 240 may also perform a channel retargeting operation. The message management server 110 may monitor events such as user behaviors in one channel 150 and decide to send follow up messages in a message series to the users on a different channel. For example, the message management server 110 may determine an application churn risk with respect to a user. In response to the churn risk being higher than a threshold, the message management server 110 may decide to change an in-app message to another channel that is less reliant on the application (e.g., an email channel). The message management server 110 may monitor the interaction or lack of action of the users with one or more messages to determine whether the user receives messages on alternative channels. The message management server 110 may switch from a channel 150 that is tied to one or more applications (e.g., push notification, in-app message, web notification, instant messages in a chat application) to another channel 150 that is more independent. In some embodiments, the channel selection engine 240 may use a LLM to select one or more channels for transmitting or distributing a message. U.S. patent application Ser. No. 15/646,008, entitled “Churn Prediction with Machine Learning,” filed on Jul. 10, 2017, is incorporated by reference for all purposes.

The message transmission engine 245 formats messages in appropriate forms, applies certain communication protocols and transmits the messages to message recipients 130. In some embodiments, the message transmission engine 245 may receive text and images of a message payload from a message publisher 120. For example, the message publisher 120 may design a message using an application provided by the message management server 110. Certain message channels and user computing devices 132 may require a message format in order for the message to be transmitted. For example, an SMS message may not contain an image. The format of a push notification may depend on the operating system of the user computing device 132. The appearances of certain messages may also be affected by the display resolution of the user computing devices 132. The message transmission engine 245 may package a message payload based on the selected channel. The message transmission engine 245 may convert the payload to an appropriate format that is compatible with a message channel, such as JSON, XML, key-value pairs, HTML, etc. Certain channels may also be associated with specific communication protocols. For example, emails may use standard mail protocols, such as Simple Mail Transfer Protocol (SMTP). A message may also need certain headers to be transmitted. The message transmission engine 245 may generate the message payload and convert the payload to one or more network packets to be sent to the message recipients 130.

The message transmission engine 245 may also check rules and timing that may restrict the transmission of a message to a specific message recipient 130. For example, a message publisher 120 or a message recipient 130 may restrict the timing for transmitting certain messages (e.g., a do-not-disturb period). There may also be other rules that restrict the transmission of messages to certain recipients 130. The transmission of message may also be subject to one or more privacy settings of the end users, such as options that limit the channels used, options that limits tracking of data and usage, types of messages that are authorized to be sent, subscription and unsubscribe options, etc.

The front-end interface engine 250 may be a software application interface that is provided and operated by the message management server 110. For example, the message management server 110 may provide a software system for message publishers 120 to design and manage various messages, message series, and message campaigns. Examples of the GUI elements of the front-end interface engine 250 for configuring in-app UI elements and/or standalone UIs are shown in FIGS. 6A-D and 7A-B. The application provided by the message management server 110 may be distinguished from the application 134 shown in FIG. 1. The application provided by the message management server 110 may be an application for message publishers 120 to manage their message campaigns. In contrast, the application 134 may be provided by a message publisher 120 for its end users. For example, the application 134 may be a retail business application in which users can purchase items and manage coupons. The application provided by the message management server 110 provides a management platform for the retail business application to manage its message campaigns, such as promotional and marketing messages and two-way messaging to be sent to end users.

The front-end interface engine 250 may take different forms. In one embodiment, the front-end interface engine 250 may control or be in communication with an application that is installed in a client device 125. For example, the application may be a cloud-based SaaS or a software application that can be downloaded in an application store (e.g., APPLE APP STORE, ANDROID STORE). The front-end interface engine 250 may be a front-end software application that can be installed, run, and/or displayed at a client device 125. The front-end interface engine 250 also may take the form of a webpage interface of the message management server 110 to allow message publishers 120 to access data and results through web browsers. In another embodiment, the front-end interface engine 250 may not include graphical elements but may provide other ways to communicate with message publishers 120, such as through APIs. The API may be in compliance with any common API standards such as Representational State Transfer (REST), query-based API, Webhooks, etc. The data transferred through the API may be in formats such as JSON and XML.

The machine learning training engine 255 trains machine learning models used by the message management server 110. The machine learning engine 255 may train any of the machine learning models deployed by the model serving system 150. The message management server 110 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training engine 255 generates the set of parameters for a machine learning model by “training” the machine learning model. Once trained, the machine learning model uses the set of parameters to transform inputs into outputs.

The machine learning training engine 255 trains a machine learning model based on a set of training examples. Each training example includes input data to which the machine learning model is applied to generate an output. For example, each training example may include message recipient data, message publisher data, event data, or data on rules and strategies provided by message publishers. In some cases, the training examples also include a label which represents an expected output of the machine learning model. In these cases, the machine learning model is trained by comparing its output from input data of a training example to the label for the training example.

The machine learning training engine 255 may apply an iterative process to train a machine learning model whereby the machine learning training engine 255 trains the machine learning model on each of the set of training examples. To train a machine learning model based on a training example, the machine learning training engine 255 applies the machine learning model to the input data in the training example to generate an output. The machine learning training engine 255 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training engine 255 updates the set of parameters for the machine learning model based on the score generated by the loss function. For example, the machine learning training engine 255 may apply gradient descent to update the set of parameters.

In some embodiments, the machine learning training engine 255 may train an LLM to design a message series. A message series includes a series of related messages. The machine learning training engine 255 may train the LLM to design a message series, including the number of messages in the series, the content of each message (e.g., text, images, video, audio, etc.), the order of each message, the start and end conditions of each message, message recipients of the series, message branching, trigger conditions, timing between messages, and channels to be used for each message (e.g., SMS, email, etc.). Training examples may include past message series or chat histories. In some embodiments, the training examples may be labeled based on feedback from message publishers 120. For example, the message management server 110 may present the message publisher 120 with a message series and receive feedback in the form of revisions or changes to the message series. In some embodiments, the training examples may be labeled based on feedback from message recipients 130. For example, the message management server 110 may ask a message recipient 130 to like/dislike a message or to rate a message from a message series on a scale of 1 to 10. As another example, the message management server 110 may ask the message recipient 130 to provide written feedback for the message. In some embodiments, the training examples may be labeled based on whether a message recipient 130 interacted with the message, for example opened an email, responded to an SMS message, or performed a conversion event like making a monthly payment or clicking on an advertisement that is sent as a message. In some embodiments, the training examples may be labeled based on whether a message recipient 130 opted out of a message series, for example replied “STOP” to a text message in a series. As the LLM is trained based on the feedback, it learns features of a message series that elicit good feedback from a message recipient 130 or more frequent interactions. As an example, the LLM may infer an ideal number of messages for a message series or an ideal time between messages in a series.

In some embodiments, the machine learning training engine 255 may train multiple LLMs, with an LLM corresponding to a particular message publisher 120. The machine learning training engine 255 may train an LLM based on content associated with the particular message publisher 120, such as previous message series or chat history between the particular message publisher 120 and various message recipients 130 or product offerings of the message publisher 120. By training an LLM for a particular message publisher 120, the machine learning training engine 255 trains the LLM to generate message series more particular to the message publisher 120. For example, if a message publisher only sends message series through instant messaging, the LLM may learn through training to output message series that include instant messages rather than email messages. Training in this way also allows for the LLM to produce message content that more closely aligns with the style, tone, and brand voice of messages already sent by the message publisher. For example, if the past messages of the message publisher are humorous in tone, the LLM may learn through training to output message content that is humorous in tone.

Similarly, the machine learning training engine 255 may train an LLM to design a message series for a particular line of offering associated with the message publisher 120. For example, the machine learning training engine 255 may train the LLM to design a message series for a new ice cream flavor. Training data may include material associated with the line of offering. Associated material may include any text or images associated with the line of offering, for example a presentation or social media post describing the line of offering. To use the ice cream flavor example, the machine learning training engine 255 may train the LLM using text describing the flavor profile of the ice cream.

In some embodiments, the machine learning training engine 255 may train an LLM to design message series for a particular industry. For example, the machine learning training engine 255 may train an LLM to design a message series for message publishers 120 associated with the airline industry or the fashion industry. Training data may include past message series or chat histories associated with message publishers 120 of the particular industry.

In some embodiments, the machine learning training engine 255 may train an LLM to design message series for particular channel (e.g., email, SMS, or app). For example, the machine learning training engine 255 may train an LLM to generate email message series based on training examples including past email messages. The machine learning training engine 255 may train a separate LLM to generate text message series and a different LLM to generate a message series for in-app messages.

The data store 260 stores trained machine learning models trained by the machine learning training engine 255. For example, the data store 260 may store the set of parameters for a trained machine learning model on one or more non-transitory, computer-readable media. The data store 260 uses computer-readable media to store data, and may use databases to organize the stored data.

In some embodiments, the machine learning models hosted by the model serving system 150 may already be trained by a separate entity from the entity responsible for the message management server 110. In another embodiment, when the model serving system 150 is included in the message management server 110, the machine-learning training engine 255 may further train parameters of the machine learning model based on data specific to the message management server 110 stored in the data store 260. As an example, the machine- learning training engine 255 may obtain a pre-trained transformer language model and further fine tune the parameters of the transformer model using training data stored in the data store 260. The machine-learning training engine 255 may provide the model to the model serving system 150 for deployment.

### Example Message Object Hierarchy

FIG. 3 is a block diagram illustrating an example message object hierarchy that may be used with the message management server 110, in accordance with some embodiments. A primary message plan 310 may include multiple series 320. The primary message plan 310 may also be referred to as a message campaign. Each message series 320 may be referred to as a message journey. Each message series 320 may include one or more messages.

The message series 320 in the primary message plan 310 may be connected in any suitable ways, branched or linear, cyclic or acyclic. The primary message plan 310 may be associated with a set of target recipient criteria that specify which candidate message recipients 130 may enter the message campaign associated with the primary message plan 310. The selection criteria may also be the trigger condition of the first message series A in the primary message plan 310. For example, a candidate message recipient 130 who meets the trigger condition of the first message series A will receive the first message in the message series A and be enrolled in the primary message plan 310. Each message series 320 may be associated with an end condition that is discussed above with reference to the message series management engine 225 in FIG. 2. In some embodiments, a message series 320 may include two or more alternative end conditions, such as the condition 1 and the condition 2 shown in FIG. 3. The message management server 110 may enroll the message recipient 130 to another message series based on the fulfillment of one of the alternative conditions. In some embodiments, except the first message series A, other message series' start condition may be the end condition of the preceding message series based on the branching and connections among the message series 320.

The end condition of a message series 320 may be a goal of the message series 320. For example, the goal of sending a series of messages to a message recipient 130 may be to induce the recipient to perform a certain action. The message management server 110 may receive an event notification from a user computing device 132 or from the message publisher 120. The action of the message recipient 130 meeting the end condition of a message series 320 may be a goal of the message series 320. The inaction of the message recipient 130 may be end condition of the same message series 320. Based on the end condition, the message recipient 130 is routed to another succeeding message series 320. Based on the end conditions of various message series 320, the primary message plan 310 provides a goal-to-goal branching of message series 320.

Each message series 320 may include one or more messages 330 that may be connected in any suitable ways, branched or linear, cyclic or acyclic. A message publisher 120 may arrange the order and branching of the messages 330 and compose each message 330. The message publisher 120 may design the payload 332, the channel setting 334, and the conditions 336 triggering a specific message. The message payload 332 may include text, image contents, and multimedia contents such as voice, videos, and music. The channel setting 334 may be based on the channel selection rules as discussed above with reference to the orchestration strategy management engine 220. The message publisher 120 may also specify criteria related to channel retargeting or allow the message management server 110 to automatically perform the channel retargeting. The message publishers 120 may also specify the conditions 336 for triggering a message 330 to be sent. The conditions 336 may specify that a succeeding message is sent automatically or after a time delay. The conditions 336 may also specify a mobile event notification for the triggering of a special message. A message 330 may be skipped if the conditions 336 are not met. Other possible conditions are discussed above with reference to the message series management engine 225.

In a message series 320, one or more conditions may include responses from the message recipient so that the message series 320 is an example of two-way messaging series. The message management server 110 may perform an action based on the response. For example, the message publisher 120 may design a message series that classifies possible responses into various categories. The message publisher 120 may define the action for each category. For example, for a response that specifies a purchase action, the message series 320 may include a condition that directs the message management server 110 to complete the purchase transaction. For another response that specifies the end user's interest in a particular product item, the message series 320 may include a branch of subsequent messages that are to be sent to the message recipients to further promote the product item. In some embodiments, the message management server 110 may automatically determine the action to be taken based on the response or may automatically draft and send a message to be sent as part of the message series 320, as described with respect to the automated action engine 233 of FIG. 2.

While digital marketing and commerce is used as an example of the implementation if a two-way messaging series, two-way messaging may be used in various other settings, such as managing user preferences (e.g., via UI preference center messages), customer service, customer reengagement, distribution of announcement, management of emergency, boarding pass management, bank service, subscription management, personal messaging, group administration, survey, and any other suitable implementations, whether the implementation is public or private, commercial or governmental, mass distribution or personalized messages, and product related or service related.

### Example Two-way Messaging Transmission Process

FIG. 4 is an interaction diagram illustrating a set of interactions 400 between entities of the system environment 100 to manage in-app UI overlay, in accordance with some embodiments. The set of interactions 400 illustrated in FIG. 4 represents specific sets of instructions that may be stored in a computer-readable medium, such as memory. The instructions, when executed by one or more processors of the depicted entities, cause the one or more processors to perform the described interactions. As depicted in FIG. 4, the set of interactions 400 is performed by a message publisher device 402 (e.g., the client server 125 or another computing device associated with the message publisher 120), a message management server 404 (e.g., the message management server 110), an SDK 406 (e.g., the SDK 136), an application 408 (e.g., the application 134), and a user device 410 (e.g., the user computing device 132). The set of interactions 400 depicted in FIG. 4 is merely an example set of interactions, and in other embodiments the set of interactions may include fewer, additional, or different actions performed by the same or different entities.

In the set of interactions 400, the message publisher device 402 provides 412 a configuration for an in-app UI message to the message management server 404. In the embodiment depicted in FIG. 4, the in-app UI element message describes a UI element for in-app display in the application 408. As an example, an administrator of the application 408 may interact with one or more GUIs provided by the message management server 404 on the message publisher device 402 to generate configuration data for an in-app UI message, as described above with reference to the FIG. 1. As depicted in FIG. 4, the in-app UI message includes a configuration for a UI element for in-app display in the application 408. The configuration data may further include other information, such as design representation of the in-app UI element.

After receiving the configuration for the in-app UI message, the message management server 404 stores 414 the in-app UI message configuration. For example, the message management server 404 may store the configuration in a data store corresponding to a message publisher associated with the message publisher device 402. The message management server 404 further provides 416 configuration data for the in-app UI message to the SDK 406. For instance, the message management server 404 may provide some or all of the configuration data included in the configuration provided by the message publisher device 402. In particular, the configuration data includes one or more trigger conditions and one or more display criteria for the in-app UI element described by the configuration for the in-app UI message, as described in greater detail below with reference to interactions 418-422.

Using the provided configuration data 416, the SDK 406 listens 418 for the one or more in-app UI trigger conditions included in the configuration data. For example, the SDK 406 may add the in-app UI element defined by the configuration data to a set of active in-app UI elements for which the SDK 406 monitors the application 408 for trigger conditions. At some time after the SDK 406 begins to listen 418, the application 408 provides 420 an indication that the one or more trigger conditions are satisfied to the SDK 406. For example, the application 408 may provide a mobile event notification to the SDK 406 indicative of the one or more trigger conditions, as described above with reference to the message series management engine 225. As another example, the SDK 406 may process data describing user actions or other events received from the application 408 to determine that the one or more trigger conditions are satisfied. After determining that the trigger condition is satisfied, the SDK 406 determines 422 that display criteria for the in-app UI element are satisfied. The display criteria may include various rules for displaying the in-app UI element, such as criteria defining what types or segments of users the in-app UI element can be displayed to (e.g., based on user demographics or user message subscriptions, etc.), criteria defining one or more states of the application 408 that the in-app UI element can be displayed in (e.g., a particular interface of the application 408 that the in-app UI element is displayed with), criteria defining a duration of the display of the in-app UI element, criteria defining a frequency at which the in-app UI element can be displayed, or any other suitable display criteria. In cases where the SDK 406 determines that the display criteria are not satisfied, the SDK 406 may monitor the application 408 for the display criteria to be satisfied or may abort a current attempt to display of the in-app UI element.

After determining 422 that the display criteria are satisfied, the SDK 406 requests deferred information for the in-app UI element. Deferred information includes information usable for rendering the in-app UI element that is stored on the message management server 404. For example, deferred information may include additional configuration data included in the configuration for the in-app UI message that was not provided as part of interaction 416. Additionally, or alternatively, deferred information may include information determined by the message management server 404 by processing configuration data in the configuration for the in-app UI message. Responsive to the request 424, the message management server 404 determines 426 the deferred information for the in-app UI element and provides 430 the deferred information to the SDK 406. In some cases, the in-app UI element may not be associated with any deferred information and some or all of the interactions 424, 246, or 430 may be skipped. As indicated by the dashed line, the message management server 404 may optionally determine 428 personalized content for the in-app UI element. For example, the personalized content may include information customized to a user of the user device, such as personal information of the user or information determined based on historical interactions by the user with the application 408 or the user device 410. The message management server 404 may provide the personalized content to the SDK 406 with the deferred information or separately. In the same or different embodiments, the message management server 404 or the SDK 406 may determine that the in-app UI element should not be displayed based on deferred information, in which case the SDK 406 may abort display of the in-app UI element.

After receiving deferred information for the in-app UI element, the SDK 406 prepares 432 the in-app UI element for display. For example, the SDK 406 may retrieve asset files for rendering the in-app UI element, such as images, audio, video, icons, or other relevant assets. Such assets may be included in the configuration data for the in-app UI element or may obtained elsewhere, e.g., from the message management server 404 or another entity. Additionally, or alternatively, the SDK 406 may pre-render the in-app UI element for providing to the application 408 after the application 408 is ready to display the in-app UI element. For example, the SDK 406 may process a design representation for the in-app UI element included in configuration data received from the message management server 404 in order to render the in-app UI element, as described above with reference to the SDK 136. After preparing the In-app UI element for display, the SDK 406 provides 434 a rendered version of the in-app UI element to the application 408. The rendered version of the in-app UI element may be overlayed on top of the existing application 408. For instance, the SDK 406 may provide the rendered in-app UI element to the application for rendering over a native UI of the application 408 (e.g., as a popup or widget).

After receiving the rendered in-app UI element, the application 408 displays 436 the rendered in-app UI element via a native application UI of the application 408 on an electronic display of the user device 410. For example, the application 408 may render the native application UI overlaid with the rendered in-app UI element. Alternatively, the application 408 may render the native application UI with the render in-app UI element integrated into a portion of the native application UI. For example, if the in-app UI element is a banner, the application 408 may render the native application UI with the banner seamlessly integrated into a suitable portion of the native application UI.

As indicated by the dashed line, the user device 410 may optionally receive a user input to the in-app UI element displayed on the electronic display of the user device 410. For example, the in-app UI element may include one or more interactable features, such as a button link, or a message box within which the user may submit a message. In this case, a user of the user device 410 may provide a user input by interacting with the one or more interactable features, such as by selecting one of the interactable features or by providing an input value (e.g., a numerical or textual value). The application 408 may optionally provide 440 information corresponding to the user input to the SDK 406. Similarly, the SDK 406 may optionally provide 442 information corresponding to the user input to the message management server 404. Based on the provided information, the message management server 404 may perform various operations, such as transmitting one or more additional messages or message series to the SDK 406 or another channel, or updating information corresponding to the application 408, the user device 410, the user of the user device 410. The message management server 404, through an automated action engine (e.g., automated action engine 233), may use automatically determine the operation to be taken based on the user input. For example, the message management server 404 may transmit one or more automatically drafted messages to the SDK 406.

In some embodiments, the message management server 404 and/or the SDK 406 may facilitate rendering of in-app UIs for the application 408 that include web views (e.g., rendered HTML windows) integrated into in-app UI elements provided by the message management server 404. As an example, the application 408 or SDK 406 installed on the user device 410 may not be configured to render some or all of an in-app UI element described by configuration data (e.g., a design representation) in an in-app UI message received from the message management server. In this case, the message management server 404 and/or the SDK 406 may perform a backup process to render the relevant in-app UI element by rendering some or all of the in-app UI element using a web view (e.g., as defined by HTML or another web-based markup language, CSS elements, JavaScript, etc.). If the web view represents a portion of an in-app UI element, the SDK 406 may seamlessly integrate the web view into an overall rendering of the in-app UI element, e.g., to appear as if rendered without a web view. As an example, if an in-app UI element is a list including a container and a list items within the container, the SDK 406 may render the container via processing of a design representing for the in-app UI element and render one or more of the individual items within the list as web views using a web markup language. The web markup language used to render the web views may be included in configuration data provided to the SDK 406 by the message management server 402.

FIG. 5A is an interaction diagram illustrating a set of interactions 500 between entities of the system environment 100 to manage in-app dynamic preference centers, in accordance with some embodiments. The set of interactions 500 illustrated in FIG. 5A represents specific sets of instructions that may be stored in a computer-readable medium, such as memory. The instructions, when executed by one or more processors of the depicted entities, cause the one or more processors to perform the described interactions. As depicted in FIG. 5A, the set of interactions 500 is performed by a message publisher device 502 (e.g., the client server 125 or another computing device associated with the message publisher 120), a message management server 504 (e.g., the message management server 110), an SDK 506 (e.g., the SDK 136), an application 508 (e.g., the application 134), and a user device 510 (e.g., the user computing device 132). The set of interactions 500 depicted in FIG. 5A is merely an example set of interactions, and in other embodiments the set of interactions may include fewer, additional, or different actions performed by the same or different entities.

In the set of interactions 500, the message publisher device 502 provides 512 a configuration for an in-app preference center message to the message management server 504. The in-app preference center message describes a preference center UI for in-app display in the application 508, e.g., as described above with reference to interaction 412 of the set of interactions 400. As an example, an administrator of the application 508 may use the platform provided by the message management server 504 on the message publisher device 502 to generate configuration data for a preference center UI, as described above with reference to the FIG. 1. The configuration for the in-app dynamic preference center includes the types of selections and option menus from which an end user may select. By selecting different preferences, the end user may further cause the application to be changed according to the preference. The message publisher may adjust the preference choices available to the end user through the platform provided by the message management server 504.

After receiving the configuration for the in-app preference center, the message management server 504 stores 514 the preference center configuration. For example, the message management server 504 may store the configuration in a data store corresponding to a message publisher associated with the message publisher device 502. The message management server 504 further provides 516 configuration data for the preference center UI to the SDK 506. For instance, the message management server 504 may provide some or all of the configuration data included in the configuration provided 512 by the message publisher device 502.

After receiving the configuration data for the preference center UI, the SDK 506 enables 518 navigation to the in-app preference center UI from within the application 518. For example, the SDK 506 may communicate with the application 508 in order to integrate a button, link, message box or other UI element into a UI of the application 508 that can receive user interactions to prompt the application 508 to display the preference center UI. The SDK 506 and/or the application 508 may embed an in-app UI element in an interface of the application 508 for navigating to in-app the preference center UI without considering some or all of the conditions described above with reference to interface 420-436. For example, the SDK 506 and/or application 508 may display the UI element in an interface of the application 508 every time the interface is displayed by the user device 510 without considering additional trigger conditions or display criteria.

After enabling 518 navigation to the in-app preference center UI, the user device 510 receives 526 a request from a user of the user device 510 to navigate to the preference center UI. In some cases, the user may provide the request by interacting with an in-app UI element displayed in an interface of the application 508, e.g., as described above with reference to the interaction 518. In other cases, the user device 510 may display a notification via one or more channels (e.g., a push notification, email, SMS, etc.) including a deep link to the in-app preference center UI, such as described by optional interactions 520-524. In this case, the user device 510 may receive 526 the request based on a user interaction with the notification. As an example of this case, the message publisher device 502 requests 520 a preference center UI notification to be displayed on one or more user devices via one or more channels. In some embodiments, the user many provide the request by providing a message in a message box displayed in an interface of the application 508. For example, the user may type “where is the preference center?” or “go to preference center” or even just “preference center” into the message box. Based on the request 520, the message management server 504 instructs 522 the application 508 to provide a preference center UI notification. The message management server 504 may instruct 522 the application 508 via the SDK 506 or may communicate directly with the application 508. Responsive to the instructions, the application 508 provides the preference center UI notification to the user device 510 for display. In the embodiment where the user provides a request through a message box, the message management server 504 may, using an automated action engine (e.g., automated action engine 233), automatically determine an action to be taken based on the message provided by the user. For example, the action in response to a user provided request of “preference center” may be to instruct 522 the application 508 to provide a preference center UI notification.

After receiving the navigation request, the application 508 requests 528 the preference center UI from the SDK 506. Based on the request 528, the SDK 506 prepares 530 the preference center UI for display using the configuration data provided by the message management server 504. The SDK 506 may perform similar actions to prepare 530 the preference center UI for display as those described above with reference to the interaction 432 of the set of interactions 400. In particular, the SDK 506 may determine display constraints, assets, and/or data requirements for the preference center UI. The SDK 506 further obtains 532 preference state information for the application 508 and/or the user device 510. The preference state information may include a current set of preferences for the application 508 and/or the 510. The preference state information may additionally, or alternatively, include information describing historical actions by a user of the application 508 or the user device 510, such as topics that the user has indicated an interest in on the application 508. After obtaining 532 the state information, the SDK 506 provides 534 a rendered preference center UI to the application 508. The SDK 506 may render the preference center UI using the configuration data, information determined as part of preparing 530 the preference center UI for display, the preference state information, or some combination thereof. In some embodiments, the SDK 506 obtains various information usable to display the preference center UI from the message management server 504 at some time before the application 508 requests 528 the preference center UI, e.g., in order to reduce latency. For example, the SDK 506 may periodically request relevant information from the message management server 504.

After receiving the rendered preference center UI, the application 508 displays 536 the preference center UI on an electronic display of the client device 510. For instance, the application 508 may display the preference center UI as a widget within the application 508. After displaying the preference center UI, the user device 510 receives 538 a user interaction with the preference center UI that indicates an update to the state information. For example, a user may provide an input indicating a change to a current preference, such as subscribing or unsubscribing to messages associated with the message publisher. In other cases, the application 508 or another system component communicates changes to preferences or other updates to the SDK 506 or the message management server 504 without receiving a user interaction with a displayed in-app preference center UI (e.g., via API function calls). In such cases, the SDK 506 may update a display of the in-app preference center UI based on changes communicated by the application 508 or other system component.

Based on the interaction, the SDK 506 determines an update to the preference state information that reflects the update indicated by the user interaction. The SDK 506 provides 540 the updated state information to the message management server 504. As an example, the SDK 506 may provide updated state information to the message management server 504 corresponding to a relevant subset of an overall set of preference state information. In this case, the message management server 504 may subscribe to updates to particular preferences or preference state information at the SDK 506. In some embodiments, the SDK 506 may provide the user interaction directly to the message management server 404. For example, the SDK 506 may provide the message management server 404 with a message input by the user so that the message management server 404 may automatically determine the action to be taken from the message and automatically perform the action. Using the updated state information, the message management server 504 updates 542 the preference state information stored at the message management server 504.

In some embodiments, the message management server 504 provides configuration data for in-app UI elements to the SDK 506 that include information corresponding to an in-app preference center. For example, an in-app UI element may be an in-app tour that includes information explaining features of the application 508 related to a preference center. In this case, in-app UI elements of the in-app tour may include a button or other interactable element for configuring a particular preference within the corresponding preference center. In response to a user interaction with the button or other interactable elements, the SDK 506 may perform a set of operations to update relevant preference state data, as described above with reference to interactions 538-542.

FIG. 5B is a flowchart for a method of generating a message series with a large language model (LLM), in accordance with some embodiments. FIG. 5C is a flowchart for a method of inferring whether an automated response or action can be generated for a message, in accordance with some embodiments. Alternative embodiments may include more, fewer, or different steps from those illustrated in FIGS. 5B and 5C, and the steps may be performed in a different order from that illustrated in FIGS. 5B and 5C. These steps may be performed by a message management server (e.g., message management server 110). Additionally, each of these steps may be performed automatically by the message management server without human intervention.

As described in FIG. 5B, the message management server 110 receives 550 inputs describing a message series to be designed. The message series include messages to be sent to a message recipient. The inputs may be input by a message publisher, such as the message publisher 120. The inputs be free text inputs of inputs selected from a dropdown menu. The inputs may describe the structure of the message series (e.g., start and end conditions, channels to use for each message, trigger conditions, number of messages etc.) or the content of each message (e.g., context of the message, tone of the message, keywords to include or exclude, etc.). The message management server 110 generates 552 a prompt for input to a LLM. The prompt includes a request to design the message series based on the received inputs. The message management server 110 provides 554 the prompt to a model serving system (e.g., model serving system 160) for execution by the LLM. The message management server 110 receives 556, from the model serving system, the message series generated by executing the LLM. The message management server 110 transmits 558 messages of the generated message series to the message recipient (e.g., message recipient 130).

The message management server 110 receives 560, from one or more client devices, a message from a conversation sent from the message recipient 130 to the message publisher 120. The message management server 110 generates 562 a prompt for input to a machine learning language model. The prompt may specify at least the message and a request to infer whether an automated action can be performed for the message. The message management server 110 provides 565 the prompt to a model serving system (e.g., model serving system 160) for execution by the machine learning language model. The message management server 110 receives 570, from the model serving system 160, a response generated by executing the machine learning language model on the prompt. The message management server 110 parses 575 the response from the model serving system 160 to extract an automated action to perform based on the message. The message management server 110 compares 580 the automated action extracted from the response to a set of rule actions to identify whether a rule action that corresponds to the automated action is present in the set of rule actions. Responsive to identifying that the corresponding rule action is present, the message management server 110 performs 585 the automated action and sends an automated response to the message recipient 120.

### Example Graphical User Interfaces

FIGS. 6A-E are conceptual diagrams illustrating a set of example graphical user interfaces (GUIs) configured to receive configuration data for in-app UI elements, in accordance with some embodiments. The GUIs shown in FIG. 6A through FIG. 8 may also be referred to as a portal for message publisher, which may be part of a SaaS portal provided by the message management server 110. The GUIs depicted in FIGS. 6A-E may be provided by the message management server 110 to a message publisher computing device (e.g., the client server 125) to receive configuration data for in-app UI elements from the message publisher 120, such as described above with reference to the front-end interface engine 250. As depicted in FIGS. 6A-E, the set of GUIs are particularly configured to receive one or more in-app UI elements representing an application tour. An application tour may include one or more in-app UI elements (e.g., popups) that include information explaining one or more features of an application (e.g., the application 134). One skilled in the art will appreciate that similar GUIs can be used to generate other types of in-app UI elements.

FIG. 6A illustrates an example GUI 600 configured to receive configuration data describing settings for an in-app tour. In the embodiment shown, the GUI 600 is configured to facilitate user adjustment of settings related to scheduling, categorizing, and tagging the in-app tour. In other embodiments the GUI 600 may be configured to facilitate user adjustment of fewer, additional, or different settings for the in-app tour. As depicted in FIG. 6A, the GUI 600 includes toggle switches corresponding to individual types of settings. In response to one if the toggle switches being toggled by a user, the GUI 600 may display additional information and/or interactable elements for configuring the relevant type of setting, such as via a dropdown menu. For example, if the toggle switch for the “start date” setting is toggled, the GUI 600 may display additional interactable elements configured to receive a start date for display of UI elements for the in-app tour.

FIG. 6B illustrates an example GUI 610 configured to receive configuration data describing target users for an in-app tour. In the embodiment shown, the GUI 610 is configured to receive a user selection of a type of target user segment for the in-app tour. In particular, the target user segments include “all users,” “specific users,” or “test users.” In other embodiments the GUI 610 may be configured to receive user selection of fewer, additional, or different types of target user segments for the in-app tour. In response to a user selection of one of the target user segments by a user, the GUI 610 may display additional information and/or interactable elements for configuring setting for the relevant target user segment, such as via a popup menu.

FIG. 6C illustrates an example GUI 620 configured to receive configuration data describing content for an in-app tour. In the embodiment shown, the GUI 620 is configured to facilitate design of one or more in-app UI elements. The GUI 620 includes interactable elements for configuring general settings of the in-app tour content, e.g., a style, dismiss button behavior, dismiss button color, and a button position. Additionally, the GUI 620 includes a virtual mobile computing device screen for simulating an appearance of an in-app UI element as displayed in an application. The virtual mobile computing device screen has an associated button to “add content,” and in response to a user interaction with the “add content button” the GUI 620 may display additional information and/or interactable elements for configuring the visual appearance of the relevant UI element, such as via a separate content customization GUI. Furthermore, the GUI 620 includes an interactable button immediately below the GUI labels at the top of the GUI 620 for adding additional virtual mobile computing device screens for designing additional UI elements for the in-app tour. In other embodiments the GUI 620 may be include fewer, additional, or different mechanisms for designing content of the in-app tour.

FIG. 6D illustrates an example GUI 630 configured to receive configuration data describing trigger conditions for an in-app tour. In the embodiment shown, the GUI 630 is configured to facilitate user adding and/or adjustment of trigger events for one or more in-app UI elements of the in-app tour (e.g., an initial UI element) Additionally, the GUI 630 includes mechanisms for adjusting display criteria for the in-app tour, e.g., a screen of an application that must be displayed in order for UI elements of the in-app tour to be displayed and a duration that must elapse before UI elements of the in-app tour can be displayed after previously being displayed. Similarly to the GUI 600, the GUI 630 includes toggle switches corresponding to individual types of display criteria, wherein the GUI 630 may display additional information and/or interactable elements for configuring the relevant type of display criteria, such as via a dropdown menu. In other embodiments the GUI 630 may be configured to facilitate adding and/or adjusting fewer, additional, or different types of trigger conditions, display criteria, or other conditions of the in-app tour.

FIG. 6E illustrates an example GUI 640 configured to receive input from a user for use in generating a journey. In the embodiment shown, the GUI 640 is configured to receive a set of user selections. The user may select what to generate a journey for (e.g., announcing new ice cream flavor), where the message recipients will receive messages (e.g., Email/SMS/App), when the user received messages (e.g., upon opening an app), keywords to include (e.g., summer) and exclude (e.g., sugar), the tone of the message (e.g., playful), and the max number of messages to include in the journey (e.g., 4 messages). In other embodiments the GUI 640 may be configured to receive user selection in the form of free text input, for example allowing the user to type in a response rather than selecting from a set of options. In other embodiments the GUI 640 may be include fewer, additional, or different mechanisms for receiving input from a user for use in generating a journey.

FIGS. 7A-B are conceptual diagrams illustrating a set of example graphical user interfaces (GUIs) configured to receive configuration data for in-app preference centers, in accordance with some embodiments. The GUIs depicted in FIGS. 7A-B may be provided by the message management server 110 to a message publisher computing device (e.g., the client server 125) to receive configuration data for in-app preference centers from the message publisher 120, such as described above with reference to the front-end interface engine 250. One skilled in the art will appreciate that similar GUIs can be used to generate other types of in-app UIs.

FIG. 7A illustrates an example GUI 700 configured to receive configuration data describing general information for a new in-app preference center. For example, the message management server 110 may provide the GUI 700 for display on a message publisher computing device responsive to a request from the message publisher computing device to add a new preference center for an application (e.g., the application 134). As depicted in FIG. 7A, the GUI 700 includes interactable elements for receiving information that generally identifies a new in-app preference center, including a name, a type, a unique identifier, and a description. In other embodiments the GUI 700 may include interactable elements for receiving fewer, additional, or different information that generally identifies the in-app preference center.

FIG. 7B illustrates an example GUI 710 configured to receive configuration data describing functionality for an in-app preference center UI. Similarly to the GUI 630 describe above with reference to FIG. 6D, the GUI 710 includes a virtual mobile computing device screen for simulating an appearance of an in-app preference center UI as displayed in an application. The GUI 710 further includes interactable elements for providing information to populate the in-app preference center UI with content, e.g., UI elements for configuring user preferences. As depicted in FIG. 7B, information provided using the interactable elements is reflected on the simulated appearance of the in-app preference center. In other embodiments the GUI 710 may include interactable elements for providing fewer, additional, or different information for populating the in-app UI preference center with content. For example, the GUI 710 may include an interactable element that populates the in-app preference center UI with a message box, allowing the end user to engage in two-way message exchange, where the message management server may respond automatically.

In some embodiments, the message management server 110 may generate design representations of in-app UI elements (e.g., in-app tours or preference centers) using a structure corresponding to interactive elements of the GUIs depicted in FIGS. 6A-D or 7A-B. For example, the message management server may generate a markup language representation of an in-app UI element that defines in-app UI elements based on content added to a virtual mobile computing device on the GUI 620 or 710.

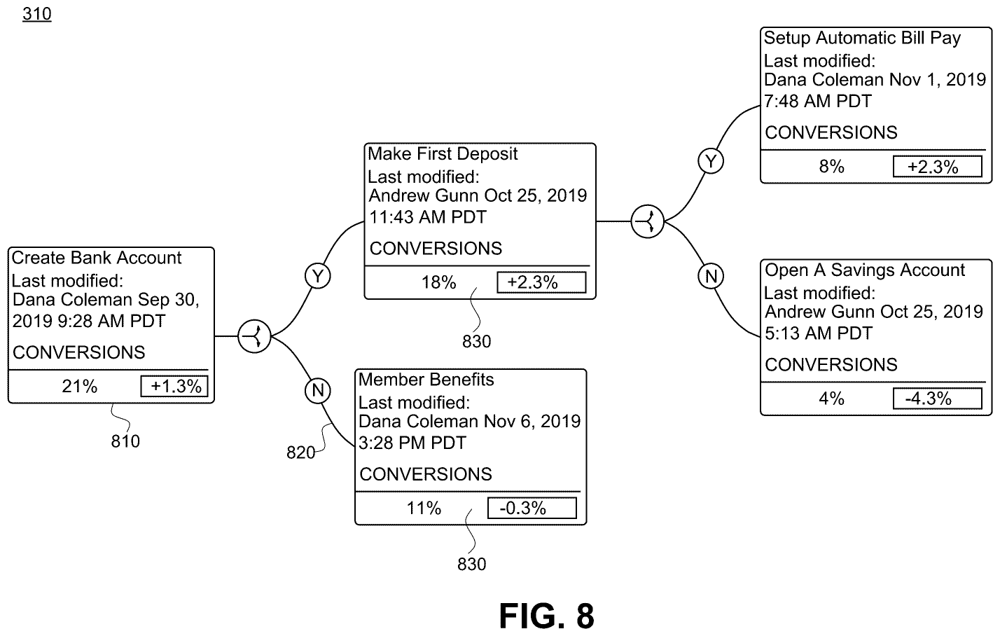

FIG. 8 is an example of a visual representation of a primary message plan 310 that includes real time statistics, in accordance with some embodiments. The message management server 110 may provide a platform (e.g., an online application) for various message publishers 120 to design and build one or more primary message plans 310. The primary message plan 310 may be displayed at a GUI of a client device 125 of a message publisher 120. The visual representation of a primary message plan 310 may include multiple nodes 810 and edges 820. The nodes are represented by the rectangular boxes. Each node represents a message series 320. An edge connecting two nodes represents a transition between two message series 320. If one or more message series includes commercial offering, such as in-app purchases offerings, the GUI may also display conversion rate of the commercial offering.

### Computing Machine Architecture

FIG. 9 is a block diagram illustrating components of an example computing machine that is capable of reading instructions from a computer-readable medium and execute them in a processor (or controller). A computer described herein may include a single computing machine shown in FIG. 9, a virtual machine, a distributed computing system that includes multiples nodes of computing machines shown in FIG. 9, or any other suitable arrangement of computing devices.

By way of example, FIG. 9 shows a diagrammatic representation of a computing machine in the example form of a computer system 900 within which instructions 924 (e.g., software, source code, program code, bytecode, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 9 may correspond to any software, hardware, or combined components shown in FIGS. 1 and 2, including but not limited to, the message management server 110, the client server 125, the user computing device 132 and various engines, interfaces, terminals, and machines shown in FIG. 2. While FIG. 9 shows various hardware and software elements, each of the components described in FIG. 1 or FIG. 2 may include additional or fewer elements. Further, the instructions may correspond to the functionality of components and interfaces described with FIGS. 1-8.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 924 that specify actions to be taken by that machine. Further, while only a single machine is illustrated, the term “machine” and “computer” may also be taken to include any collection of machines that individually or jointly execute instructions 924 to perform any one or more of the methodologies discussed herein.

The example computer system 900 includes one or more processors 902 such as a CPU (central processing unit), a GPU (graphics processing unit), a TPU (tensor processing unit), a DSP (digital signal processor), a system on a chip (SOC), a controller, a state machine, an application-specific integrated circuit (ASIC), a field-programmable gate array (FPGA), or any combination of these. Parts of the computing system 900 may also include a memory 904 that store computer code including instructions 924 that may cause the processors 902 to perform certain actions when the instructions are executed, directly or indirectly by the processors 902. Instructions can be any directions, commands, or orders that may be stored in different forms, such as equipment-readable instructions, programming instructions including source code, and other communication signals and orders. Instructions may be used in a general sense and are not limited to machine-readable codes.

One and more methods described herein improve the operation speed of the processors 902 and reduces the space required for the memory 904. For example, the methods described herein reduce the complexity of the computation of the processors 902 by applying one or more novel techniques that simplify the steps in training, reaching convergence, and generating results of the processors 902. The algorithms described herein also reduces the size of the models and datasets to reduce the storage space requirement for memory 704.

The performance of certain of the operations may be distributed among the more than processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. Even though in the specification or the claims may refer some processes to be performed by a processor, this should be construed to include a joint operation of multiple distributed processors.

The computer system 700 may include a main memory 904, and a static memory 906, which are configured to communicate with each other via a bus 908. The computer system 900 may further include a graphics display unit 910 (e.g., a plasma display panel (PDP), a liquid crystal display (LCD), a projector, or a cathode ray tube (CRT)). The graphics display unit 910, controlled by the processors 902, displays a GUI (GUI) to display one or more results and data generated by the processes described herein. The computer system 900 may also include an alphanumeric input device 912 (e.g., a keyboard), a cursor control device 914 (e.g., a mouse, a trackball, a joystick, a motion sensor, or another pointing instrument), a storage unit 916 (a hard drive, a solid state drive, a hybrid drive, a memory disk, etc.), a signal generation device 918 (e.g., a speaker), and a network interface device 920, which also are configured to communicate via the bus 708.

The storage unit 916 includes a computer-readable medium 922 on which is stored instructions 924 embodying any one or more of the methodologies or functions described herein. The instructions 924 may also reside, completely or at least partially, within the main memory 904 or within the processor 902 (e.g., within a processor's cache memory) during execution thereof by the computer system 900, the main memory 904 and the processor 902 also constituting computer-readable media. The instructions 924 may be transmitted or received over a network 926 via the network interface device 920.

While computer-readable medium 922 is shown in an example embodiment to be a single medium, the term “computer-readable medium” should be taken to include a single medium or multiple media (e.g., a centralized or distributed database, or associated caches and servers) able to store instructions (e.g., instructions 924). The computer-readable medium may include any medium that is capable of storing instructions (e.g., instructions 924) for execution by the processors (e.g., processors 902) and that causes the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### Example Embodiments

In some aspects, the techniques described herein relate to a computer-implemented method, including: receiving, from a software development kit (SDK) by a message management server, a channel identifier that represents an in-application communication channel of a software application that imports the SDK as part of the software application, the software application developed by a message publisher, and the SDK developed by the message management server; associating the channel identifier with an end user identifier of an end user; receiving, from the message publisher via a graphical user interface, configuration data describing an in-application user interface (UI) element for display by the software application, the configuration data including a trigger condition for displaying the in-application UI element; transmitting a message to the SDK via the in-application communication channel, wherein the message includes the trigger condition from the configuration data for the in-application UI element; responsive to the SDK determining that the trigger condition is satisfied, providing additional configuration data from the configuration data for the in-application UI element to the SDK, wherein the SDK uses the additional configuration data to render the in-application UI element for display in the software application; receiving a response from the SDK, the response corresponding to an interaction with the rendered in-application UI element by the end user in the software application and forwarded to the SDK; and performing, by the message management server, an action based on the response.

In some aspects, the techniques described herein relate to a computer-implemented method, including: receiving, from a software development kit (SDK) by a message management server, a channel identifier that represents an in-application communication channel of a software application that imports the SDK as part of the software application, the software application developed by a message publisher, and the SDK developed by the message management server; associating the channel identifier with an end user identifier of an end user; receiving, from the message publisher via a graphical user interface, configuration data describing an in-application preference center user interface (UI) for display by the software application; transmitting a message to the SDK via the in-application communication channel, wherein the message includes configuration data for the in-application preference center UI; responsive to the SDK receiving a request to display the in-application preference center UI, providing preference state data corresponding the end user to the SDK, wherein the SDK uses the preference state data to render the in-application preference center UI for display in the software application; receiving a response from the SDK, the response corresponding to an interaction with the rendered in-application preference center UI element by the end user in the software application and forwarded to the SDK, the response indicating an update to the preference state data; and updating, by the message management server, the preference state data based on the update indicated by the response.

In some aspects, the techniques described herein relate to a system including: a software development kit (SDK) included in a software application, the software application importing the SDK as part of the software application, the software application developed by a message publisher; a graphical user interface configured to allow the message publisher to provide, at the graphical user interface, configuration data describing in-application user interface (UI) elements for display by the software application; and a message management server in communication with the SDK and the graphical user interface, the message management server including one or more processors and memory configured to store computer code including instructions, the instructions, when executed by the one or more processors, cause the one or more processors to: receive, from the SDK, a channel identifier that represents an in-application communication channel of the software application; associate the channel identifier with an end user identifier of an end user; receive, from the message publisher via the a graphical user interface, configuration data describing an in-application user interface (UI) element for display by the software application, the configuration data including a trigger condition for displaying the in-application UI element; transmit a message to the SDK via the in-application communication channel, wherein the message includes the trigger condition from the configuration data for the in-application UI element; responsive to the SDK determining that the trigger condition is satisfied, provide additional configuration data from the configuration data for the in-application UI element to the SDK, wherein the SDK uses the additional configuration data to render the in-application UI element for display in the software application; receive a response from the SDK, the response corresponding to an interaction with the rendered in-application UI element by the end user in the software application and forwarded to the SDK; and performing, by the message management server, an action based on the response.

In some aspects, the techniques described herein relate to a system including: a software development kit (SDK) included in a software application, the software application importing the SDK as part of the software application, the software application developed by a message publisher; a graphical user interface configured to allow the message publisher to provide, at the graphical user interface, configuration data describing in-application preference center user interfaces (UIs) for display by the software application; and a message management server in communication with the SDK and the graphical user interface, the message management server including one or more processors and memory configured to store computer code including instructions, the instructions, when executed by the one or more processors, cause the one or more processors to: receive, from the SDK, a channel identifier that represents an in-application communication channel of the software application; associate the channel identifier with an end user identifier of an end user; receive, from the message publisher via a graphical user interface, configuration data describing an in-application preference center user interface (UI) for display by the software application; transmit a message to the SDK via the in-application communication channel, wherein the message includes configuration data for the in-application preference center UI; responsive to the SDK receiving a request to display the in-application preference center UI, provide preference state data corresponding the end user to the SDK, wherein the SDK uses the preference state data to render the in-application preference center UI for display in the software application; receive a response from the SDK, the response corresponding to an interaction with the rendered in-application preference center UI element by the end user in the software application and forwarded to the SDK, the response indicating an update to the preference state data; and update, by the message management server, the preference state data based on the update indicated by the response.

### Additional Considerations

Beneficially, the message management server provides a platform for various message publishers to delegate the task of distributing messages via various channels to the message management server. Transmission of messages through different channels may be technically challenging for many organizations because each channel may have its own requirement, communication protocol, infrastructure with which organizations may not be equipped. By providing a user-friendly user interface to the message publishers for them to build message series, the message management server manages the technical difficulties for the message publishers. The appearance, contents, and overall feeling of the message may be changed significantly when a different channel is used to deliver the message. The graphical user interface may also provide simulations of the messages as rendered in end users' computing devices, thereby providing the message publishers with previews of the messages that could have dramatically different appearances when transmitted via different channels and rendered in different operating systems and models of computing devices. The message management also allows more complex interaction such as two-way messaging to be implemented. The use of SDK allows the message management server to automatically implement messaging and response features across different applications that are developed by different parties.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Embodiments according to the invention are in particular disclosed in the attached claims directed to a method and a computer program product, wherein any feature mentioned in one claim category, e.g. method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject-matter which can be claimed comprises not only the combinations of features as set out in the disclosed embodiments but also any other combination of features from different embodiments. Various features mentioned in the different embodiments can be combined with explicit mentioning of such combination or arrangement in an example embodiment. Furthermore, any of the embodiments and features described or depicted herein can be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In one embodiment, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed by the specific order claimed or described in the disclosure. Some steps may be performed before others even though the other steps are claimed or described first in this disclosure.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed:

1. A computer-implemented method, comprising:
receiving, from a publisher, one or more inputs describing a payload series to be designed, the payload series including one or more content payloads to be sent to a payload recipient;
generating a prompt for input to a large language model (LLM), the prompt including a request to design the payload series based on the one or more inputs;
providing the prompt to a model serving system for execution by the LLM;
receiving, from the model serving system, the payload series generated by executing the LLM on the prompt; and
transmitting one or more content payloads of the generated payload series to the payload recipient.

2. The computer-implemented method of claim 1, further comprising:
receiving, from one or more user computing devices, a message from a conversation sent from the payload recipient to the publisher;
generating a prompt for input to a second LLM, the prompt specifying at least the message and a request to infer whether an automated action can be performed for the message;
providing the prompt to a model serving system for execution by the second LLM;
receiving, from the model serving system, a response generated by executing the second LLM on the prompt;
parsing the response from the model serving system to extract an automated action to perform based on the message;
comparing the automated action extracted from the response to a set of rule actions to identify whether a rule action that corresponds to the automated action is present in the set of rule actions; and
responsive to identifying that a corresponding rule action is present, performing the automated action and sending an automated response to the payload recipient.

3. The computer-implemented method of claim 1, wherein the one or more inputs describing the payload series to be designed describe a tone of the one or more content payloads.

4. The computer-implemented method of claim 1, wherein the one or more inputs describing the payload series to be designed describe keywords to include and exclude in the one or more content payloads.

5. The computer-implemented method of claim 1, wherein the one or more inputs describing the payload series to be designed describe start and end conditions, channels to use for each message, trigger conditions, and number of content payloads in the payload series.

6. The computer-implemented method of claim 1, wherein the LLM is trained based on training examples including past payload series associated with the publisher.

7. The computer-implemented method of claim 1, wherein the LLM is trained based on training examples including past payload series associated with an industry.

8. The computer-implemented method of claim 1, wherein the LLM is trained based on training examples including past payload series associated with a channel of communication.

9. The computer-implemented method of claim 1, wherein the LLM is trained based on training examples including past payload series labeled by feedback received from payload recipients of the past payload series.

10. The computer-implemented method of claim 9, wherein the feedback describes whether the payload recipients of the past payload series performed conversion events.

11. A non-transitory computer readable storage medium comprising stored program code, the program code comprising instructions that, when executed, cause a processor system to:
receive, from a publisher, one or more inputs describing a payload series to be designed, the payload series including one or more content payloads to be sent to a payload recipient;
generate a prompt for input to a large language model (LLM), the prompt including a request to design the payload series based on the one or more inputs;
provide the prompt to a model serving system for execution by the LLM;
receive, from the model serving system, the payload series generated by executing the LLM on the prompt; and
transmit one or more content payloads of the generated payload series to the payload recipient.

12. The non-transitory computer readable storage medium of claim 11, further comprising:
receiving, from one or more user computing devices, a message from a conversation sent from the payload recipient to the publisher;
generating a prompt for input to a second LLM, the prompt specifying at least the message and a request to infer whether an automated action can be performed for the message;
providing the prompt to a model serving system for execution by the second LLM;
receiving, from the model serving system, a response generated by executing the second LLM on the prompt;
parsing the response from the model serving system to extract an automated action to perform based on the message;
comparing the automated action extracted from the response to a set of rule actions to identify whether a rule action that corresponds to the automated action is present in the set of rule actions; and
responsive to identifying that a corresponding rule action is present, performing the automated action and sending an automated response to the payload recipient.

13. The non-transitory computer readable storage medium of claim 11, wherein the one or more inputs describing the payload series to be designed describe a tone of the one or more content payloads.

14. The non-transitory computer readable storage medium of claim 11, wherein the one or more inputs describing the payload series to be designed describe keywords to include and exclude in the one or more content payloads.

15. The non-transitory computer readable storage medium of claim 11, wherein the one or more inputs describing the payload series to be designed describe start and end conditions, channels to use for each message, trigger conditions, and number of content payloads in the payload series.

16. The non-transitory computer readable storage medium of claim 11, wherein the LLM is trained based on training examples including past payload series associated with the publisher.

17. The non-transitory computer readable storage medium of claim 11, wherein the LLM is trained based on training examples including past payload series associated with an industry.

18. The non-transitory computer readable storage medium of claim 11, wherein the LLM is trained based on training examples including past payload series associated with a channel of communication.

19. The non-transitory computer readable storage medium of claim 11, wherein the LLM is trained based on training examples including past payload series labeled by feedback received from payload recipients of the past payload series.

20. A computer system, comprising:
a processor system comprising at least one computer processor; and
a non-transitory computer readable storage medium comprising stored program code, the program code comprising instructions, the instructions when executed causes the processor system to:
receive, from a publisher, one or more inputs describing a payload series to be designed, the payload series including one or more content payloads to be sent to a payload recipient;
generate a prompt for input to a large language model (LLM), the prompt including a request to design the payload series based on the one or more inputs;
provide the prompt to a model serving system for execution by the LLM;
receive, from the model serving system, the payload series generated by executing the LLM on the prompt; and
transmit one or more content payloads of the generated payload series to the payload recipient.
